(19) United States
(12) Patent Application Publication
(10) Pub. No.: US 2026/0362464 A1
(43) Pub. Date: Nov. 12, 2026

(54) CHANNEL STATE INFORMATION REFERENCE SIGNAL RESOURCE MANAGEMENT FOR LOWER-LAYER TRIGGERED MOBILITY

(71) Applicant: QUALCOMM Incorporated, San Diego, CA (US)

(72) Inventors: Doohyun SUNG, Basking Ridge, NJ (US); Punyaslok PURKAYASTHA, San Diego, CA (US); Jelena DAMNJANOVIC, Del Mar, CA (US); Prasada Veera Reddy KADIRI, San Diego, CA (US)

(21) Appl. No.: 19/667,401

(22) Filed: May 4, 2026

Related U.S. Application Data
(60) Provisional application No. 63/801,569, filed on May 7, 2025.

(51) Int. Cl. H04W 72/51; H04L 5/00; H04W 72/23

(52) U.S. Cl. CPC H04W 72/51; H04L 5/0094; H04L 5/0096; H04W 72/23

(57) ABSTRACT

This disclosure provides methods for a user equipment (UE) to determine which channel state information reference signal (CSI-RS) resources to monitor after performing a lower-layer triggered mobility (LTM) cell switch. For example, the UE may receive one or more messages that explicitly indicate which CSI-RS resources may be monitored after completing the LTM cell switch. Additionally, or alternatively, the UE may identify one or more conditions for activating or deactivating CSI-RS resources after performing the LTM cell switch. In some examples, one or more network entities may determine which CSI-RS resources are to be activated or deactivated after a UE performs an LTM cell switch. For example, the target network entity may determine which CSI-RS resources are to be activated or deactivated. Additionally, or alternatively, a source network entity may determine which CSI-RS resources may be activated or deactivated.

### CROSS REFERENCE

The present Application for Patent claims the benefit of U.S. Provisional Patent Application No. 63/801,569 by SUNG et al., entitled “CHANNEL STATE INFORMATION REFERENCE SIGNAL RESOURCE MANAGEMENT FOR LOWER-LAYER TRIGGERED MOBILITY,” filed May 7th, 2025, assigned to the assignee hereof, and expressly incorporated by reference herein.

### TECHNICAL FIELD

This disclosure relates generally to wireless communication, and more specifically to systems, devices, methods, and techniques associated with channel state information reference signal (CSI-RS) resource management for lower-layer triggered mobility (LTM).

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a network entity is described. The method may include obtaining a lower-layer triggered mobility (LTM) cell switch notification message including an indication of a pre-cell switch activation status of one or more channel state information reference signal (CSI-RS) resources at a user equipment (UE), determining a post-cell switch activation status of each of the one or more CSI-RS resources based on the pre-cell switch activation status, and outputting one or more control messages including an indication of the post-cell switch activation status.

A network entity for wireless communications is described. The network entity may include a processing system that includes processor circuitry and memory circuitry that stores code. The processing system may be configured to cause the network entity to obtain an LTM cell switch notification message including an indication of a pre-cell switch activation status of one or more CSI-RS resources at a UE, determine a post-cell switch activation status of each of the one or more CSI-RS resources based on the pre-cell switch activation status, and output one or more control messages including an indication of the post-cell switch activation status.

Another network entity for wireless communications is described. The network entity may include means for obtaining an LTM cell switch notification message including an indication of a pre-cell switch activation status of one or more CSI-RS resources at a UE, means for determining a post-cell switch activation status of each of the one or more CSI-RS resources based on the pre-cell switch activation status, and means for outputting one or more control messages including an indication of the post-cell switch activation status.

A non-transitory computer-readable medium storing code for wireless communications is described. The code may include instructions executable by one or more processors (e.g., directly, indirectly, without pre-processing, after pre-processing) to obtain an LTM cell switch notification message including an indication of a pre-cell switch activation status of one or more CSI-RS resources at a UE, determine a post-cell switch activation status of each of the one or more CSI-RS resources based on the pre-cell switch activation status, and output one or more control messages including an indication of the post-cell switch activation status.

In some examples of the method, network entities, and non-transitory computer-readable medium described herein, determining the post-cell switch activation status may include operations, features, means, or instructions for selecting respective sets of the one or more CSI-RS resources to activate or deactivate for the UE based on the pre-cell switch activation status.

Some examples of the method, network entities, and non-transitory computer-readable medium described herein may further include operations, features, means, or instructions for receiving, via the LTM cell switch notification message, an indication of one or more measurement results corresponding to a set of measurements of one or more CSI-RSs, where selecting the respective sets of the one or more CSI-RS resources may be based on the one or more measurement results and the pre-cell switch activation status.

Some examples of the method, network entities, and non-transitory computer-readable medium described herein may further include operations, features, means, or instructions for selecting the respective sets of the one or more CSI-RS resources may be in accordance with one or more activation criteria.

In some examples of the method, network entities, and non-transitory computer-readable medium described herein, outputting the one or more control messages may include operations, features, means, or instructions for outputting the one or more control messages to one or more second network entities.

In some examples of the method, network entities, and non-transitory computer-readable medium described herein, the one or more second network entities may be associated with a source cell prior to an LTM cell switch, a candidate cell for the LTM cell switch, or any combination thereof.

In some examples of the method, network entities, and non-transitory computer-readable medium described herein, outputting the one or more control messages may include operations, features, means, or instructions for outputting the one or more control messages to the UE.

Some examples of the method, network entities, and non-transitory computer-readable medium described herein may further include operations, features, means, or instructions for outputting a set of CSI-RSs via the one or more CSI-RS resources to the UE in accordance with the post-cell switch activation status.

In some examples of the method, network entities, and non-transitory computer-readable medium described herein, the indication of the post-cell switch activation status includes an indication of one or more CSI-RS resource identifiers corresponding to one or more activated CSI-RSs, one or more transmission configuration indicator state identifiers corresponding to the one or more activated CSI-RSs, one or more CSI-RS resource identifiers corresponding to one or more deactivated CSI-RSs, one or more transmission configuration indicator states corresponding to the one or more deactivated CSI-RSs, or any combination thereof.

In some examples of the method, network entities, and non-transitory computer-readable medium described herein, the indication of the pre-cell switch activation status includes an indication of one or more CSI-RS resource identifiers corresponding to one or more activated CSI-RSs, one or more transmission configuration indicator state identifiers corresponding to the one or more activated CSI-RSs, one or more CSI-RS resource identifiers corresponding to one or more deactivated CSI-RSs, one or more transmission configuration indicator states corresponding to the one or more deactivated CSI-RSs, or any combination thereof.

In some examples of the method, network entities, and non-transitory computer-readable medium described herein, the LTM cell switch notification message may be obtained via an F1-AP interface.

In some examples of the method, network entities, and non-transitory computer-readable medium described herein, the LTM cell switch notification message may be obtained via an Xn-AP interface.

A method for wireless communications by a first network entity is described. The method may include outputting an LTM cell switch command, determining a post-cell switch activation status of each of one or more CSI-RS resources at a UE associated with the LTM cell switch command, where the post-cell switch activation status is based on a pre-cell switch activation status of the one or more CSI-RS resources at the UE, and outputting, based on the LTM cell switch command, an LTM cell switch notification message including an indication of the post-cell switch activation status of each of the one or more CSI-RS resources.

A first network entity for wireless communications is described. The first network entity may include a processing system that includes processor circuitry and memory circuitry that stores code. The processing system may be configured to cause the first network entity to output an LTM cell switch command, determine a post-cell switch activation status of each of one or more CSI-RS resources at a UE associated with the LTM cell switch command, where the post-cell switch activation status is based on a pre-cell switch activation status of the one or more CSI-RS resources at the UE, and output, based on the LTM cell switch command, an LTM cell switch notification message including an indication of the post-cell switch activation status of each of the one or more CSI-RS resources.

Another first network entity for wireless communications is described. The first network entity may include means for outputting an LTM cell switch command, means for determining a post-cell switch activation status of each of one or more CSI-RS resources at a UE associated with the LTM cell switch command, where the post-cell switch activation status is based on a pre-cell switch activation status of the one or more CSI-RS resources at the UE, and means for outputting, based on the LTM cell switch command, an LTM cell switch notification message including an indication of the post-cell switch activation status of each of the one or more CSI-RS resources.

A non-transitory computer-readable medium storing code for wireless communications is described. The code may include instructions executable by one or more processors (e.g., directly, indirectly, without pre-processing, after pre-processing) to output an LTM cell switch command, determine a post-cell switch activation status of each of one or more CSI-RS resources at a UE associated with the LTM cell switch command, where the post-cell switch activation status is based on a pre-cell switch activation status of the one or more CSI-RS resources at the UE, and output, based on the LTM cell switch command, an LTM cell switch notification message including an indication of the post-cell switch activation status of each of the one or more CSI-RS resources.

Some examples of the method, first network entities, and non-transitory computer-readable medium described herein may further include operations, features, means, or instructions for outputting, via the LTM cell switch notification message, an indication of the pre-cell switch activation status of the one or more CSI-RS resources.

In some examples of the method, first network entities, and non-transitory computer-readable medium described herein, the indication of the pre-cell switch activation status includes an indication of one or more CSI-RS resource identifiers corresponding to one or more activated CSI-RS resources, one or more transmission configuration indicator state identifiers corresponding to the one or more activated CSI-RS resources, one or more CSI-RS resource identifiers corresponding to one or more deactivated CSI-RS resources, one or more transmission configuration indicator states corresponding to the one or more deactivated CSI-RS resources, or any combination thereof.

In some examples of the method, first network entities, and non-transitory computer-readable medium described herein, determining the post-cell switch activation status may include operations, features, means, or instructions for selecting respective sets of the one or more CSI-RS resources to activate or deactivate for the UE based on the pre-cell switch activation status.

Some examples of the method, first network entities, and non-transitory computer-readable medium described herein may further include operations, features, means, or instructions for obtaining one or more measurement reports indicating a set of measurements of one or more CSI-RSs, where selecting the respective sets of the one or more CSI-RS resources may be based on the set of measurements and the pre-cell switch activation status.

In some examples of the method, first network entities, and non-transitory computer-readable medium described herein, the indication of the post-cell switch activation status includes an indication of one or more CSI-RS resource identifiers corresponding to one or more activated CSI-RS resources, one or more transmission configuration indicator state identifiers corresponding to the one or more activated CSI-RS resources, one or more CSI-RS resource identifiers corresponding to one or more deactivated CSI-RS resources, one or more transmission configuration indicator states corresponding to the one or more deactivated CSI-RS resources, or any combination thereof.

In some examples of the method, first network entities, and non-transitory computer-readable medium described herein, the LTM cell switch notification message may be output via an F1-AP interface.

In some examples of the method, first network entities, and non-transitory computer-readable medium described herein, the LTM cell switch notification message may be output via an Xn-AP interface.

A method for wireless communications by a UE is described. The method may include performing an LTM cell switch from a source cell to a target cell, determining, in accordance with an indication of a post-cell switch activation status for a set of CSI-RS resources, which CSI-RS resources of the set of CSI-RS resources are to be activated or deactivated after the LTM cell switch, and monitoring for one or more CSI-RSs via one or more of the set of CSI-RS resources in accordance with the post-cell switch activation status.

A UE for wireless communications is described. The UE may include a processing system that includes processor circuitry and memory circuitry that stores code. The processing system may be configured to cause the UE to perform an LTM cell switch from a source cell to a target cell, determine, in accordance with an indication of a post-cell switch activation status for a set of CSI-RS resources, which CSI-RS resources of the set of CSI-RS resources are to be activated or deactivated after the LTM cell switch, and monitor for one or more CSI-RSs via one or more of the set of CSI-RS resources in accordance with the post-cell switch activation status.

Another UE for wireless communications is described. The UE may include means for performing an LTM cell switch from a source cell to a target cell, means for determining, in accordance with an indication of a post-cell switch activation status for a set of CSI-RS resources, which CSI-RS resources of the set of CSI-RS resources are to be activated or deactivated after the LTM cell switch, and means for monitoring for one or more CSI-RSs via one or more of the set of CSI-RS resources in accordance with the post-cell switch activation status.

A non-transitory computer-readable medium storing code for wireless communications is described. The code may include instructions executable by one or more processors (e.g., directly, indirectly, without pre-processing, after pre-processing) to perform an LTM cell switch from a source cell to a target cell, determine, in accordance with an indication of a post-cell switch activation status for a set of CSI-RS resources, which CSI-RS resources of the set of CSI-RS resources are to be activated or deactivated after the LTM cell switch, and monitor for one or more CSI-RSs via one or more of the set of CSI-RS resources in accordance with the post-cell switch activation status.

Some examples of the method, UEs, and non-transitory computer-readable medium described herein may further include operations, features, means, or instructions for receiving one or more control messages including the indication of the post-cell switch activation status, where determining which CSI-RS resources to be activated or deactivated may be in accordance with the post-cell switch activation status.

In some examples of the method, UEs, and non-transitory computer-readable medium described herein, the indication of the post-cell switch activation status includes an indication of LTM channel state information resources, CSI-RS resource sets, CSI-RS resource identifiers, or any combination thereof.

In some examples of the method, UEs, and non-transitory computer-readable medium described herein, the one or more control messages include one or more radio resource control messages indicating one or more CSI-RS resources to remain activated after the LTM cell switch, one or more CSI-RS resources to activate after the LTM cell switch, one or more CSI-RS resources to remain deactivated after the LTM cell switch, one or more CSI-RS resources to deactivate after the LTM cell switch, or any combination thereof.

In some examples of the method, UEs, and non-transitory computer-readable medium described herein, the one or more control messages include one or more medium access control-control elements indicating one or more CSI-RS resources to remain activated after the LTM cell switch, one or more CSI-RS resources to activate after the LTM cell switch, one or more CSI-RS resources to remain deactivated after the LTM cell switch, one or more CSI-RS resources to deactivate after the LTM cell switch, or any combination thereof.

In some examples of the method, UEs, and non-transitory computer-readable medium described herein, the one or more medium access control-control elements include an LTM cell switch command and performing the LTM cell switch may be in accordance with the LTM cell switch command.

Some examples of the method, UEs, and non-transitory computer-readable medium described herein may further include operations, features, means, or instructions for performing a second LTM cell switch from a second source cell to a second target cell and determining which CSI-RS resources of the set of CSI-RS resources to be activated or deactivated after the second LTM cell switch, where determining which CSI-RS resources of the set of CSI-RS resources to be activated or deactivated may be in accordance with an absence of the indication of the post-cell switch activation status.

A method for wireless communications by a UE is described. The method may include performing an LTM cell switch from a source cell to a target cell, determining, in accordance with one or more activation rules that indicate a post-cell switch activation status for a set of CSI-RS resources, which CSI-RS resources of the set of CSI-RS resources are to be activated or deactivated after the LTM cell switch, and monitoring for one or more CSI-RSs via one or more of the set of CSI-RS resources in accordance with the post-cell switch activation status.

A UE for wireless communications is described. The UE may include a processing system that includes processor circuitry and memory circuitry that stores code. The processing system may be configured to cause the UE to perform an LTM cell switch from a source cell to a target cell, determine, in accordance with one or more activation rules that indicate a post-cell switch activation status for a set of CSI-RS resources, which CSI-RS resources of the set of CSI-RS resources are to be activated or deactivated after the LTM cell switch, and monitor for one or more CSI-RSs via one or more of the set of CSI-RS resources in accordance with the post-cell switch activation status.

Another UE for wireless communications is described. The UE may include means for performing an LTM cell switch from a source cell to a target cell, means for determining, in accordance with one or more activation rules that indicate a post-cell switch activation status for a set of CSI-RS resources, which CSI-RS resources of the set of CSI-RS resources are to be activated or deactivated after the LTM cell switch, and means for monitoring for one or more CSI-RSs via one or more of the set of CSI-RS resources in accordance with the post-cell switch activation status.

A non-transitory computer-readable medium storing code for wireless communications is described. The code may include instructions executable by one or more processors (e.g., directly, indirectly, without pre-processing, after pre-processing) to perform an LTM cell switch from a source cell to a target cell, determine, in accordance with one or more activation rules that indicate a post-cell switch activation status for a set of CSI-RS resources, which CSI-RS resources of the set of CSI-RS resources are to be activated or deactivated after the LTM cell switch, and monitor for one or more CSI-RSs via one or more of the set of CSI-RS resources in accordance with the post-cell switch activation status.

In some examples of the method, UEs, and non-transitory computer-readable medium described herein, the one or more activation rules indicate that the UE may be to maintain a pre-cell switch activation status corresponding to the set of CSI-RS resources.

In some examples of the method, UEs, and non-transitory computer-readable medium described herein, the one or more activation rules indicate that the UE may be to activate one or more LTM channel state information resources corresponding to at least one previously activated set of CSI-RS resources.

In some examples of the method, UEs, and non-transitory computer-readable medium described herein, the one or more activation rules indicate that the UE may be to activate one or more LTM channel state information resources corresponding to each previously activated set of CSI-RS resources.

In some examples of the method, UEs, and non-transitory computer-readable medium described herein, the one or more activation rules indicate for the UE to deactivate the set of CSI-RS resources.

Some examples of the method, UEs, and non-transitory computer-readable medium described herein may further include operations, features, means, or instructions for receiving one or more control messages indicating for the UE to activate one or more of the set of CSI-RS resources, where monitoring for the one or more CSI-RSs may be in accordance with the one or more control messages.

In some examples of the method, UEs, and non-transitory computer-readable medium described herein, the one or more activation rules indicate for the UE to selectively activate one or more of the set of CSI-RS resources in accordance with a type of resource corresponding to each of the set of CSI-RS resources, an LTM execution condition corresponding to each of the set of CSI-RS resources, a frequency band corresponding to each of the set of CSI-RS resources, an LTM channel state information resource corresponding to each of the set of CSI-RS resources, or any combination thereof.

Some examples of the method, UEs, and non-transitory computer-readable medium described herein may further include operations, features, means, or instructions for receiving one or more control messages indicating the one or more activation rules.

### BRIEF DESCRIPTION OF THE DRAWINGS

FIG. 1 shows an example of a wireless communication system.

FIG. 2 shows an example of a network architecture that supports channel state information reference signal (CSI-RS) resource management for lower-layer triggered mobility (LTM).

FIG. 3 shows an example of a signaling configuration that supports CSI-RS resource management for LTM.

FIG. 4 shows an example of a process flow that supports CSI-RS resource management for LTM.

FIG. 5 shows an example of a process flow that supports CSI-RS resource management for LTM.

FIG. 6 shows an example of a process flow that supports CSI-RS resource management for LTM.

FIG. 7 shows a block diagram of a processing system that supports CSI-RS resource management for LTM.

FIG. 8 shows a diagram of a system including a device that supports CSI-RS resource management for LTM.

FIG. 9 shows a block diagram of a processing system that supports CSI-RS resource management for LTM.

FIG. 10 shows a diagram of a system including a device that supports CSI-RS resource management for LTM.

FIGS. 11 through 14 show flowcharts illustrating methods that support CSI-RS resource management for LTM.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may perform lower-layer triggered mobility (LTM) techniques in which the UE may switch from communicating with one or more source network entities (e.g., a source distributed unit (DU) associated with a source central unit (CU)) to one or more target network entities (e.g., a target DU associated with the source CU or a target CU). In some examples, while in communication with a source network entity, the UE may monitor for and perform measurements of one or more channel state information reference signals (CSI-RSs) (e.g., semi-persistent CSI-RSs) from candidate network entities (e.g., network entities that are candidates to be targets for LTM). In such examples, however, UE and the candidate network entities may be unaware of which semi-persistent CSI-RSs to use after transitioning to a target network entity using LTM techniques. In particular, prior to an LTM-based cell switch, various CSI-RS resources may be activated or deactivated for one or more candidate cells (e.g., via a medium access control (MAC)-control element (CE)). But it may be unclear how to handle the activated CSI-RS resources after the LTM-based switch (e.g., techniques may not exist that indicate whether to stop monitoring/measurement of the activated CSI-RS resources, whether to continue monitoring/measurement of the activated CSI-RS resources, or perform some other action).

Aspects of the subject matter described in this disclosure relate to enabling the UE to determine which CSI-RSs to monitor after performing an LTM cell switch. For example, the UE may determine, based on a rule in a specification, which CSI-RS resources to monitor after performing an LTM cell switch. Additionally, or alternatively, the UE may receive a control message indicating CSI-RS resources to monitor after performing an LTM cell switch. Additionally, or alternatively, the UE may identify one or more conditions for activating or deactivating CSI-RS resources after performing an LTM cell switch. Some aspects described herein may enable target network entities to determine which CSI-RS resources are to be activated or deactivated after a UE performs an LTM cell switch. For example, the target network entity (e.g., a target DU or target CU) may determine which CSI-RS resources are to be activated/deactivated. Additionally, or alternatively, a source network entity (e.g., a source DU or source CU) may indicate (e.g., request), to the target network entity, which CSI-RS resources may be activated/deactivated. Here, the target network entity may use the indication from the source network entity (e.g., take the information included in the request into account) when determining which CSI-RS resources are to be activated/deactivated after the LTM-based switch is complete.

Particular aspects of the subject matter described in this disclosure can be implemented to realize one or more of the following potential advantages. In some examples, by configuring active and inactive CSI-RS resources following an LTM cell switch, the described techniques can be used to facilitate relatively smoother cell switches, which may increase a quality of communications and decrease a latency of the wireless communication system. For example, by enabling LTM techniques, a UE may communicate with network entities associated with a relatively highest quality of communication, which may increase a reliability of communications. By enabling configuration and activation of CSI-RS resources, the UE may provide CSI to network entities relatively faster, which may increase a reliability of communications and decrease latency in the wireless communication system.

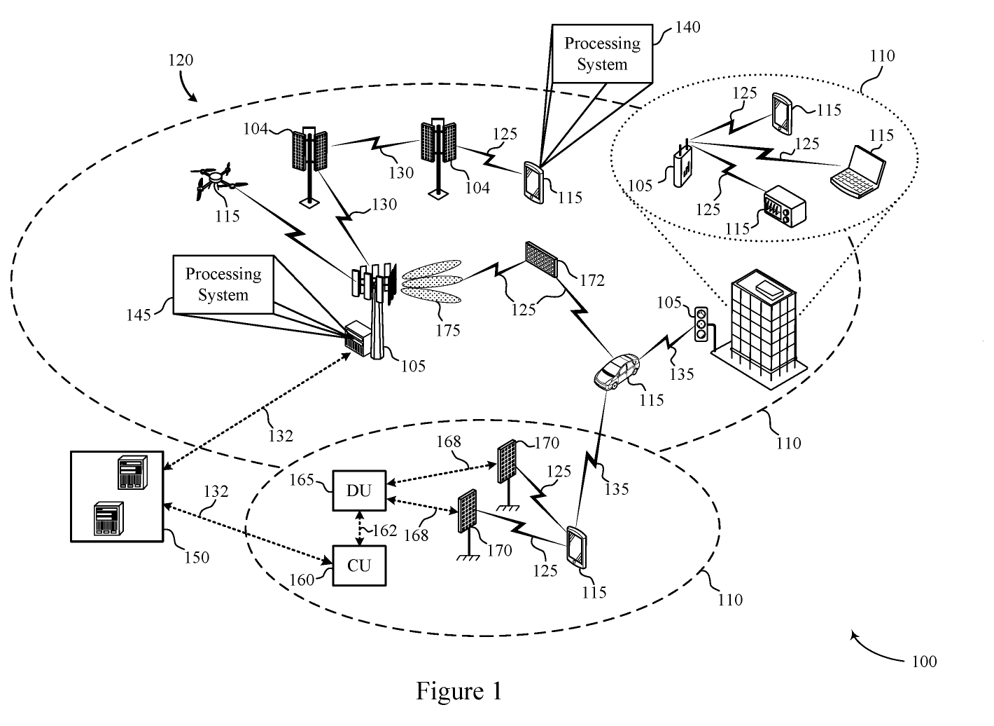

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or any combination thereof. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, multiple-input, multiple-output (MIMO) communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, CSI-RSs that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Beamforming techniques may include analog beamforming, for which at least some signal processing (such as phase shifting, amplification, signal combination) is performed in an analog domain (such as using analog components, including analog phase shifters and amplifiers, for processing respective signals of individual antenna elements). Additionally (such as in accordance with hybrid beamforming), or alternatively, beamforming techniques may include digital beamforming, for which at least some signal processing is performed in a digital domain (such as using digital processing techniques for processing respective signals of individual antenna elements).

A network entity 105 or a UE 115 may use beam sweeping techniques as part of beamforming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a specific receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105, a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by receiving according to different receive beamforming weight sets applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A quasi co-location (QCL) relationship between one or more transmissions or signals may refer to a relationship between the antenna ports (and the corresponding signaling beams) of the respective transmissions. For example, one or more antenna ports may be implemented by a network entity 105 for transmitting at least one or more reference signals (such as a downlink reference signal, a synchronization signal block (SSB), or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being quasi co-located (QCLed). QCLed signals may enable the UE 115 to derive the properties of a first signal (e.g., delay spread, Doppler spread, frequency shift, average power) transmitted via a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as CSI-RS) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relationship between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relationship between two or more directional beams used to communicate signals. Here, the spatial parameters may indicate that a first beam used to transmit a first signal may be similar (or the same) as another beam used to transmit a second, different, signal, or, that the same receive beam may be used to receive both the first and the second signal. Thus, the beam information for various beams may be derived through receiving signals from a transmitting device, where, in some cases, the QCL information or spatial information may help a receiving device efficient identify communications beams (e.g., without having to sweep through a large quantity of beams to identify a beam (e.g., the beam having a highest signal quality)). In addition, QCL relationships may exist for both uplink and downlink transmissions and, in some cases, a QCL relationship may also be referred to as spatial relationship information.

In some examples, TCI states may include one or more parameters associated with a QCL relationship between transmitted signals. For example, each TCI state includes parameters for configuring a QCL relationship between one or two downlink reference signals and the DMRS ports of PDSCH, the DMRS port of PDCCH or the CSI-RS port(s) of a CSI-RS resource. The QCL relationship is configured by a first higher layer parameter for the first downlink reference signal, and by a second higher layer parameter for the second downlink reference signal (if configured). That is, a network entity 105 may configure a QCL relationship that provides a mapping between a reference signal and antenna ports of another signal, and the TCI state may be indicated to the UE 115 by the network entity 105. In some cases, a set of TCI states (e.g., a list of TCI states) may be indicated to a UE 115 via RRC signaling, where some quantity of TCI states may be configured via RRC and one or more TCI states may be indicated (e.g., activated) via a medium access control (MAC)-control element (MAC-CE), and further indicated via DCI (e.g., within a CORESET). The QCL relationship associated with the TCI state (and further established through higher-layer parameters) may provide the UE 115 with the QCL relationship for respective antenna ports and reference signals transmitted by the network entity 105.

Network entities 105 or UEs 115 may support concurrent communication using multiple carriers, which may be referred to as carrier aggregation, for which each of the multiple carriers may be referred to as a component carrier (CC). Carrier aggregation may be used with both FDD and TDD CCs. In some examples of carrier aggregation, a CC may have acquisition signaling or control signaling that coordinates operations for other CCs. A CC may be operated in a standalone mode, such that initial acquisition and connection may be conducted by the UEs 115 via the CC, or the CC may be operated in a non-standalone mode, such that a connection is anchored using a different CC (such as of the same or a different RAT).

Additionally, or alternatively, UEs 115 may support concurrent communication via multiple network entities 105 (such as multiple base stations, multiple RUs 170, multiple DUs 165, multiple CUs 160), which may be referred to as dual connectivity (DC). Such techniques may implement a master cell group (MCG), which may refer to one or more cells associated with a primary network entity 105 (such as a network entity 105 with which a UE 115 establishes a first communication link 125), and a secondary cell group (SCG), which may refer to one or more cells associated with a secondary network entity 105 (such as a network entity 105 with which the UE 115 establishes a second communication link 125). An MCG may include a special cell (SpCell), referred to as a primary cell (PCell), that supports initial access and configuration with the MCG, and an SCG also may include an SpCell, referred to as a primary secondary cell (PSCell), that supports initial access and configuration with the SCG. An MCG, an SCG, or both also may include one or more secondary cells (SCells) that support further access with the respective group, which may implement aspects of a carrier aggregation configuration via the respective network entity 105.

Devices of the wireless communication system 100 may be configured to support one or more aspects of the described techniques for CSI-RS resource management for LTM. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support activation or deactivation of CSI-RS resources for LTM. For example, a UE 115, a source network entity 105 (e.g., a source DU), or a target network entity 105 (e.g., a target DU) may determine which CSI-RS resources to activate or deactivate after the UE 115 performs (e.g., completes) an LTM cell switch, which may enable relatively improved reliability and reduced latency in the wireless communication system 100.

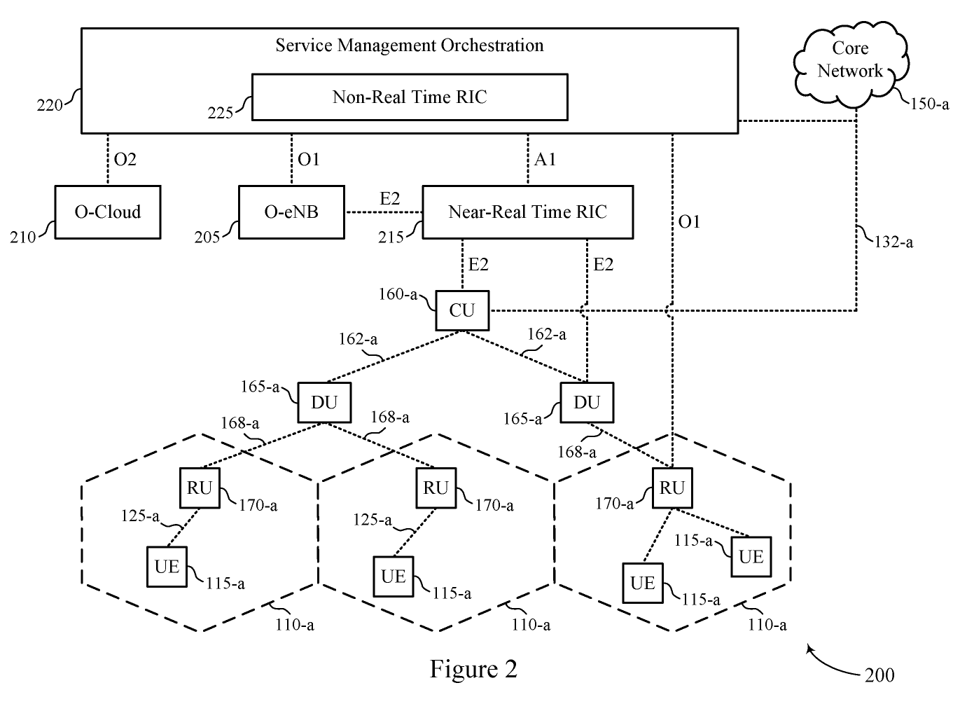

FIG. 2 shows an example of a network architecture 200 that supports CSI-RS resource management for LTM. The architecture 200 (such as a network architecture, a disaggregated base station architecture, a disaggregated RAN architecture) illustrates an example for implementing one or more aspects of a wireless communication system 100 (such as a RAN 120), and may include one or more of a CU 160-a, a DU 165-a, and an RU 170-a.

In the example of architecture 200, a CU 160-a may communicate directly with a core network 150-a via a backhaul link 132-a, or indirectly with the core network 150-a through one or more disaggregated network entities 105. A CU 160-a may be connected with a DU 165-a via a midhaul link 162-a (such as an F1, F1c, or F1u interface), and a DU 165-a may be connected with an RU 170-a via fronthaul communication link 168-a (such as an open fronthaul (FH) interface). The RUs 170-a may be associated with respective coverage areas 110-a and may communicate with UEs 115-a via one or more communication links 125-a. A UE 115-a may be served by one or more of an RU 170-a, and multiples of an RU 170-a serving a UE 115-a may be associated with one or more of a DU 165-a.

A split of functionality between one or more of a CU 160-a, a DU 165-a, and an RU 170-a is flexible and may support different functionalities depending on which functions (such as network layer functions, protocol layer functions, baseband functions, RF functions, or combination thereof) are performed at the various entities. For example, a functional split of a protocol stack may be employed such that a CU 160-a, a DU 165-a, and an RU 170-a may each support one or more different layers of the protocol stack. Additionally, or alternatively, a functional split of a protocol stack may be within a protocol layer, such that some functions for a protocol layer are performed by one of a CU 160-a, a DU 165-a, or an RU 170-a, and some other functions of the protocol layer are performed by a different one of the CU 160-a, the DU 165-a, or the RU 170-a.

A CU 160-a may host upper protocol layer (such as layer 3 (L3), layer 2 (L2)) functionality and signaling (such as RRC, SDAP, PDCP). A CU 160-a may be functionally split into CU control plane (CU-CP) and CU user plane (CU-UP) functions. A CU 160-a may be logically split into one or more CU-UP units and one or more CU-CP units. A CU-UP unit may communicate bidirectionally with the CU-CP unit via an interface (such as an E1 interface). A CU 160-a may be connected with one or more of a DU 165-a, one or more of an RU 170-a, or a combination thereof. DUs 165-a, RUs 170-a, or both may host lower protocol layers, which may include layer 1 (L1) (such as PHY layer) or L2 (such as RLC layer, MAC layer) functionality and signaling, and each may be at least partially controlled by a CU 160-a. A DU 165-a may support one or multiple different cells (such as via one or more of an RU 170-a).

The architecture 200 may include a Service Management and Orchestration (SMO) framework (such as implementing an SMO 220) configured to support RAN deployment and provisioning of non-virtualized and virtualized network entities 105. The architecture 200 also may include a RAN Intelligent Controller (RIC), types of which may include Near-Real Time (RT) or Non-RT. In some cases, a network entity 105 (such as a CU 160-a, a DU 165-a) may communicate with a Near-RT RIC 215 via an E2 link, or a Non-RT RIC 225 associated with SMO 220, or both. An RU 170-a also may be referred to as a radio head, a smart radio head, a remote radio head (RRH), a remote radio unit (RRU), or a transmission/reception point (TRP). One or more components of a disaggregated RAN architecture may be co-located, or may be located in distributed (such as separate physical) locations. One or more network entities 105 of a disaggregated RAN architecture may be implemented as virtual units (such as a virtual CU (VCU), a virtual DU (VDU), a virtual RU (VRU)) and provide network function virtualization, which may be supported by an open-cloud (O-Cloud) platform (such as an O-Cloud 210). For example, functionality of a network entity 105 may be implemented in an O-eNB 205.

The architecture 200 may support resource management (e.g., CSI-RS resource management) for LTM procedures. For example, a UE 115 may determine which resources to monitor after performing an LTM cell switch. For example, the UE 115 may receive one or more messages that explicitly indicate which resources may be monitored after completing the LTM cell switch. Additionally, or alternatively, the UE 115 may identify one or more conditions for activating or deactivating respective resources after performing the LTM cell switch. The architecture 200 may additionally, or alternatively, support a determination (e.g., by one or more network entities) of which resources are to be activated or deactivated after a UE performs an LTM cell switch. For example, a target network entity (e.g., a target CU 160 and/or a target DU 165) may determine which CSI-RS resources are to be activated or deactivated. Additionally, or alternatively, a source network entity (e.g., a source CU 160 and/or a source DU 165) may determine which CSI-RS resources may be activated or deactivated.

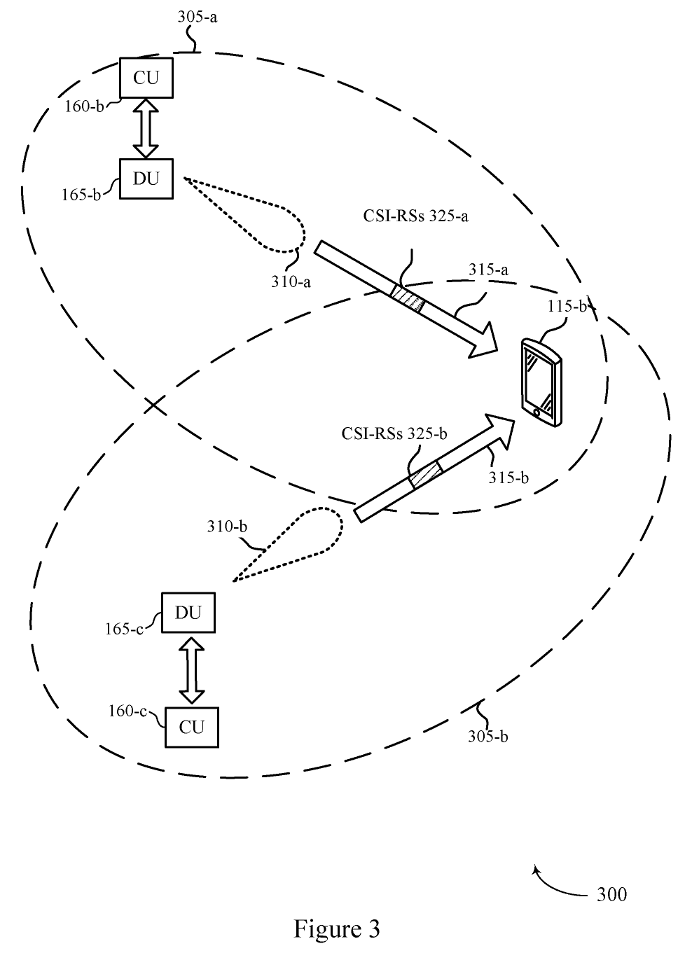

FIG. 3 shows an example of a signaling configuration 300 that supports CSI-RS resource management for LTM. The signaling configuration 300 may implement or may be implemented by aspects of the wireless communication system 100 or the network architecture 200. For example, the signaling configuration 300 may be implemented by a UE 115 (e.g., a UE 115-b) or one or more network entities 105 (e.g., a DU 165-b, a DU 165-c, a CU 160-a, a CU 160-b), which may be examples of the corresponding devices as described with reference to FIG. 1.

In some examples of the signaling configuration 300, a UE 115-b may perform monitoring of reference signals (e.g., CSI-RSs 325) via one or more channels 315 (e.g., a channel 315-a, a channel 315-b) to perform LTM (e.g., L1/L2 triggered mobility). For example, the UE 115-b may monitor for CSI-RSs 325-a transmitted in a serving cell 305-a (e.g., by a DU 165-b) via a beam 310-a, and for CSI-RSs 325-b transmitted in a serving cell 305-b (e.g., by a DU 165-c) via a beam 310-b. In some examples, for intra-cell beam management (e.g., intra-cell master cell group (MCG) or secondary cell group (SCG) LTM), the DU 165-b and the DU 165-c may be associated with a same CU 160. That is, the cell 305-a and the cell 305-b may be cells associated with a same CU 160. For inter-cell beam management (e.g., inter-cell MCG or SCG LTM), the DU 165-b and the DU 165-c may be associated with a CU 160-b and a CU 160-c, respectively.

In some examples, the DU 165-b may be associated with a serving cell and the DU 165-c may be associated with a candidate cell. For example, the UE 115-b may communicate with the DU 165-b, and the UE 115-b may measure beams 310-a of the DU 165-b and beams 310-b of the DU 165-c. Based on the measurements of the beams 310-a and the beams 310-b (e.g., if the measurements satisfy one or more measurement criteria), the DU 165-b may indicate for the UE 115-b to perform an LTM cell switch to begin communicating with the DU 165-c (e.g., a target DU 165). Accordingly, the measurements of the CSI-RSs 325 may enable LTM by the UE 115-b, which may increase a reliability of communications of the UE 115-b.

In some examples, to identify active CSI-RS resources or CSI interference measurement (CSI-IM) resources (e.g., resources over which the UE 115-b may monitor for and perform measurements of CSI-RSs 325), the UE 115-b may receive control signaling (e.g., MAC-CE signaling) that activates or deactivates the CSI-RS resources. In some examples, the control signaling may include an activation/deactivation (A/D) indicator (e.g., indicating whether to activate or deactivate an indicated CSI-RS or CSI-IM resource set), a serving cell identifier (ID) (e.g., indicating an ID of a serving cell for which the control signaling applies), a bandwidth part (BWP) ID (e.g., indicating a downlink BWP for which the control signaling applies as a codepoint of a downlink control information (DCI) BWP indicator field), a semi-persistent (SP) CSI-RS resource set ID (e.g., indicating an index of a NZP-CSI-RS-ResourceSet containing one or more non-zero power (NZP) CSI-RS resources), an IM field (e.g., indicating a presence of a SP CSI-IM resource set ID field), an SP CSI-IM resource set ID field (e.g., indicating an index of a CSI-IM-ResoruceSet containing SP CSI-IM resources), a transmission configuration indicator (TCI) state ID field (e.g., containing a TCI-StateID indicating a quasi-co location source for a resource within the SP NZP CSI-RS resource set), and one or more reserved bits. Accordingly, a MAC-CE message may indicate one or more SP CSI-RS (e.g., or CSI-IM) resource sets configured for one serving cell at a time. In some aspects, the control signaling may not partially activate or deactivate an NZP-CSI-RS (e.g., or CSI-IM) resource set. That is, the control signaling may activate or deactivate the full CSI-RS resource set.

In some examples, a control message (e.g., a MAC-CE message) may activate or deactivate SP CSI-RS resources of candidate cells (e.g., the cell 305-b of the DU 165-c). For example, for L1 event-triggered mobility, the control message may activate or deactivate an SP CSI-RS resource of one or more candidate cells (e.g., by indicating the A/D field, target configuration ID or SP CSI-RS resource set ID, the candidate cell ID, and/or a TCI state ID). The UE 115-b may accordingly measure CSI-RSs 325 from the serving DU 165-b and the candidate DU 165-c, and may transmit an LTM CSI report indicating CSI measurements of the CSI-RSs 325 (e.g., indicating an LTM CSI resource ID, associated with a list of NZP-CSI-RS resource IDs).

Such techniques may enable the activation and deactivation of CSI-RSs during preparation of LTM. In some examples, however, the UE 115-b and the DUs 165 (e.g., the DU 165-b, the DU 165-c) may be unaware of which CSI-RS resources to activate or deactivate after LTM preparation (e.g., when the UE 115-b switches from communicating with the DU 165-b to communicating with the DU 165-c as part of an LTM procedure). For example, depending on a mobility of the UE 115-b, some CSI-RS resources of candidate cells may be deactivated, and some CSI-RS resources of other candidate cells may be activated following the LTM cell switch.

In some aspects, the UE 115-b may determine which SP CSI-RS resources to activate or deactivate following an LTM cell switch based on receiving an indication (e.g., an explicit indication) from the DU 165-b or the DU 165-c. For example, the UE 115-b may receive an RRC layer indication (e.g., via an RRC message) that explicitly indicates an LTM CSI resource (e.g., LTM-CSI-ResourceConfig r18), an NZP-CSI-RS resource set, or an NZP-CSI-RS resource configured as a SP CSI-RS for the UE 115-b to activate or deactivate. The UE 115-b may accordingly determine whether the corresponding SP CSI-RSs (e.g., the LTM CSI resources, the NZP-CSI-RS resources, or the NZP-CSI-RS resource sets) should remain active or should be deactivated following the LTM cell switch. Additionally, or alternatively, the RRC message may indicate a list of LTM CSI resource IDs, NZP-CSI-RS resource set IDs, or NZP-CSI-RS resource IDs, or any combination thereof, for one or more CSI-RSs to remain activated or deactivated following the LTM cell switch.

In some examples, the UE 115-b may receive the indication via a MAC-CE message. For example, the MAC-CE message may indicate which LTM CSI resources, NZP-CSI-RS resources configured as SP CSI-RSs, or NZP-CSI-RS resource sets should remain activated or should be deactivated following the LTM cell switch. The MAC-CE may be an extension of an LTM cell switch command message (e.g., with one or more additional fields defined in the LTM cell switch command indicating the CSI-RS resources to activate or deactivate), or may be another MAC-CE message.

In some aspects, the UE 115-b may identify a default operation for activating or deactivating CSI-RS resources (e.g., in the absence of receiving an indication via RRC or MAC-CE). For example, the UE 115-b may determine to leave one or more CSI-RS resources activated in the absence of a message indicating an activation of the one or more CSI-RS resources.

Additionally, or alternatively, the UE 115-b may identify one or more rules for managing SP CSI-RS resources following the LTM cell switch. In some examples, the one or more rules may be defined (e.g., predefined, preconfigured) in one or more technical specifications. Additionally, or alternatively, the UE 115-b may receive control signaling (e.g., RRC, MAC-CE) indicating the one or more rules. In some examples, the one or more rules may be associated with a capability of the UE 115-b (e.g., as reported via one or more capability messages from the UE 115-b). In some aspects, a set of one or more activation criteria may be used to determine which SP CSI-RS resources may be activated (or deactivated) following an LTM cell switch.

In some examples, the one or more rules may indicate for the UE 115-b to perform unconditional activation of previously activated CSI-RS resources. For example, the UE 115-b may identify a pre-cell switch activation status of one or more CSI-RS resources, and may determine to maintain the pre-cell switch activation status. The pre-cell switch activation status may refer to a status (e.g., activation, deactivation) of one or more respective resources (e.g., CSI-RS resources or the like) that may be configured for the UE 115-b prior to a completion of a cell switch (e.g., an LTM-based cell switch). Additionally, or alternatively, the UE 115-b may determine a mapping rule (e.g., a mapping from SP CSI-RS resources to LTM CSI resources and LTM CSI report configurations) associated with activating one or more CSI-RS resources. For example, the UE 115-b may determine to automatically activate an LTM CSI resource for LTM CSI reporting in the target cell 305-b that is associated with at least one previously activated SP CSI-RS resource in the serving cell 305-a. Additionally, or alternatively, the UE 115-b may determine to automatically activate an LTM CSI resource for LTM CSI reporting in the target cell 305-b for which all SP CSI-RS resources were previously activated in the serving cell 305-a.

In some examples, the UE 115-b may identify a duration for an interruption time associated with performing the LTM cell switch. For example, the UE 115-b may be unavailable to monitor SP CSI-RS resources during the LTM cell switch operation. Accordingly, the UE 115-b may identify a capability or a requirement for a duration until the UE 115-b may resume monitoring of SP CSI-RS resources. The SP CSI-RS resources may therefore be activated following the duration (e.g., after the LTM cell switch).

Additionally, or alternatively, the UE 115-b may determine to unconditionally deactivate (e.g., refrain from monitoring) all previously activated SP CSI-RS resources during or following the LTM cell switch in the target cell 305-b. In such examples, the DU 165-c may continue transmitting the CSI-RSs 325-b in the deactivated resources, or may cease transmitting the CSI-RSs 325-b in the deactivated resources. The DU 165-c (e.g., the target cell) may transmit control signaling (e.g., MAC-CE signaling) to the UE 115-b indicating one or more new SP CSI-RS resources for the UE 115-b to activate following the LTM cell switch.

Additionally, or alternatively, the one or more rules may indicate for the UE 115-b to perform conditional activation of SP CSI-RS resources following the LTM cell switch. For example, the one or more rules may indicate a set of conditions for which the UE 115-b may activate CSI-RS resources in the target cell 305-b. The one or more conditions may include whether the SP-CSI-RS resources are associated with a CSI report type (e.g., semi-persistent, aperiodic, event-triggered) from the source cell 305-a or the target cell 305-b, whether the SP-CSI-RS resources are associated with a conditional LTM execution condition, whether the SP CSI-RS resources are part of an LTM CSI resource of the target cell 305-b, whether the SP CSI-RS resources are intra-frequency SP CSI-RS resources, and/or whether the SP CSI-RS resources are inter-frequency SP CSI-RS resources. In some examples, the UE 115-b may receive control signaling defining the one or more conditions. Additionally, or alternatively, the one or more conditions may be defined according to a rule in a technical specification.

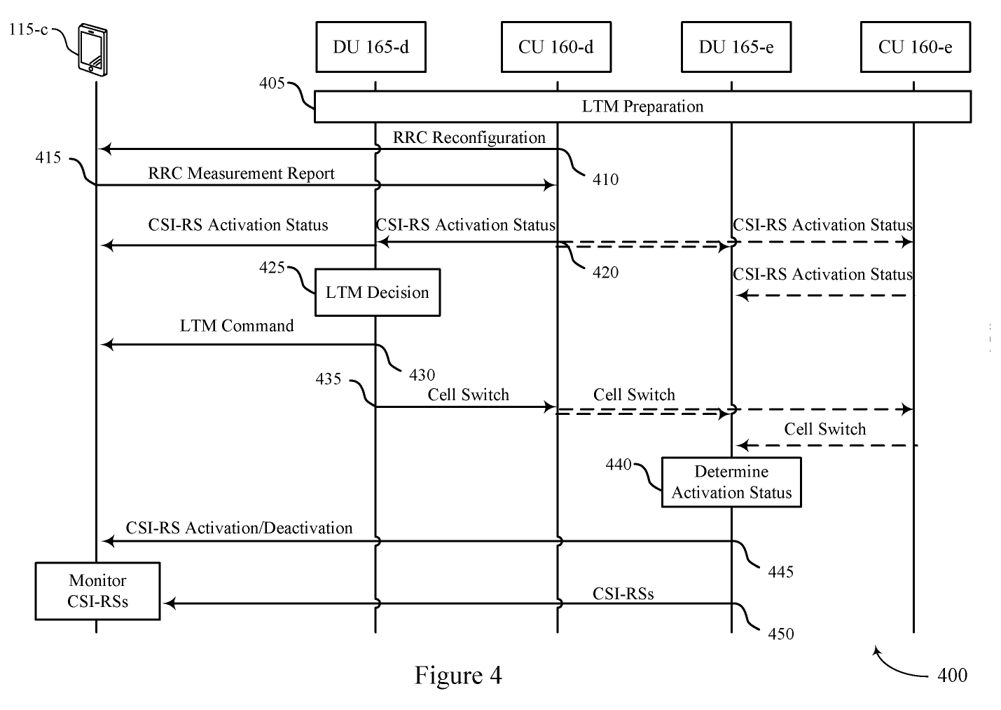

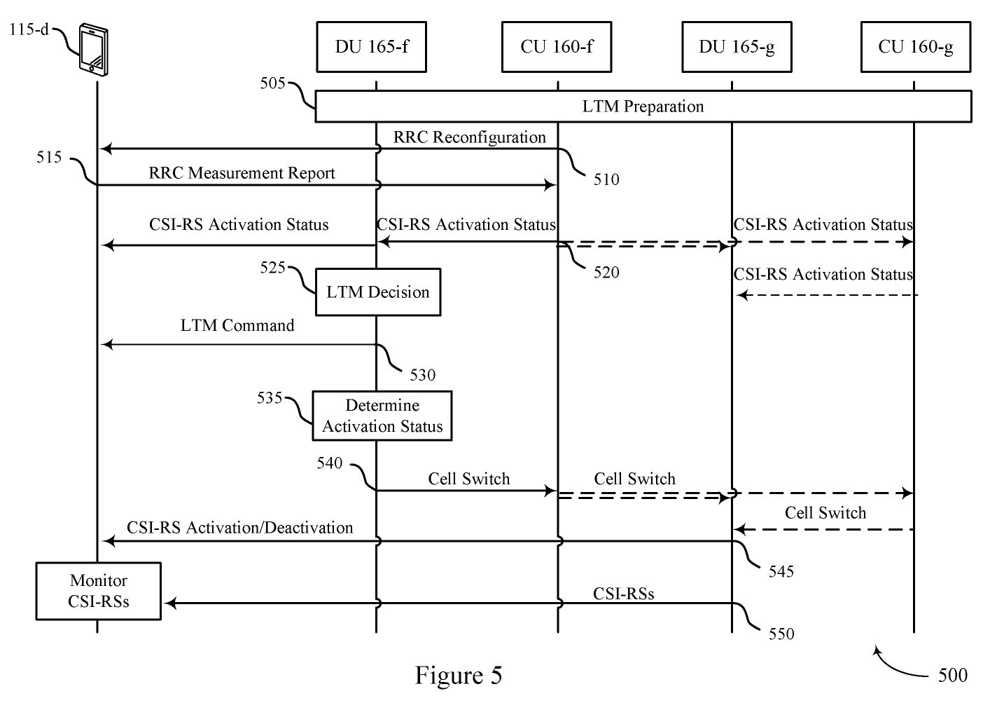

In some aspects, the DU 165-b and the DU 165-c may determine the CSI-RS resources to activate or deactivate (e.g., which CSI-RS resources to transmit CSI-RSs over and which CSI-RS resources to refrain from transmitting CSI-RSs over, respectively). In some examples, as described with reference to FIG. 4, the target DU 165-c may determine which CSI-RS resources to activate or deactivate. Additionally, or alternatively, as described with reference to FIG. 5, the source DU 165-b may determine which CSI-RS resources to activate or deactivate.

In some examples, the source DU 165-b may output pre-cell switch activation status information to the target DU 165-c. For example, the source DU 165-b may output an activation status message to the source CU 160-b. The source CU 160-b may forward the activation status message to the target CU 160-c, and the target CU 160-c may forward the activation status message to the target DU 165-c. In examples in which the source CU 160-b and the target CU 160-c are a same CU 160, the DU 165-b may output an activation status message to the CU 160, and the CU 160 may forward the activation status message to the target DU 165-c.

In some examples, the activation status information may include the activation status of SP CSI-RS resources at the UE 115-b and/or corresponding TCI state information for the SP CSI-RS resources. The activation status information may indicate activated SP CSI-RS resources (e.g., NZP-CSI-RS resources, NZP-CSI-RS resource set IDs) and corresponding TCI state information for candidate cells (e.g., all cells to which the UE 115-b may roam as part of the LTM cell switch). In some examples, the activation status information may indicate one or more deactivated resources (e.g., such that an activation status for all SP CSI-RS resources configured for the UE 115-b are indicated).

In some examples, the activation status message may indicate SP CSI-RS resources via a combination of an LTM CSI resource ID and an ordinal index within the LTM CSI resource or via a combination of NZP-CSI-RS resource (e.g., or resource set) and a candidate cell ID. In some examples, the activation status message may include a same or different representation of SP CSI-RS resources via an F1 interface (e.g., a DU to CU interface, such as from the DU 165-b and the CU 160-b or between the CU 160-c and the DU 165-c) as the representation of SP CSI-RS resources signaled via an Xn interface (e.g., a CU to CU interface, such as between the CU 160-b and the CU 160-c).

In some aspects, the DU 165-b may indicate, to the DU 165-c (e.g., via one or more CUs 160), one or more measurement results associated with the CSI-RS resources (e.g., L1 measurement results associated with SP CSI-RS resources, L3 measurement results associated with SP CSI-RS resources or QCLed synchronization signal block (SSB) resources). In some examples, the activation status information may be indicated via one or more existing F1 or Xn messages (e.g., an F1-AP cell switch notification or Xn-AP cell switch notification) or via a new F1-AP or Xn-AP message.

In some examples, as described with reference to FIG. 5, the source DU 165-b (e.g., or the source CU 160-b) may determine to update one or more CSI-RS resources activated at the UE 115-b following the LTM cell switch. For example, the source DU 165-b (e.g., or the source CU 160-b) may receive a measurement report from the UE 115-b indicating one or more L1 measurement results or L3 measurement results. The source DU 165-b may determine a list of SP CSI-RS resources to be activated and/or deactivated (e.g., and/or TCI state information associated with the SP CSI-RS resources to be activated and/or deactivated) based on the L1 measurement results, and may output the list to the source CU 160-b. In some examples, activated CSI-RS resources indicated by the source DU 165-b may be currently active resources and/or resources to be activated. Additionally, or alternatively, the source CU 160-b may determine or update the list of CSI-RS resources to be activated and/or deactivated (e.g., and/or TCI state information associated with the SP CSI-RS resources to be activated and/or deactivated) based on the L3 measurement results. The CU 160-b may output a final decision of the list of CSI-RS resources to be activated and/or deactivated (e.g., and/or TCI state information associated with the SP CSI-RS resources to be activated and/or deactivated) to the target DU 165-c (e.g., and/or one or more candidate DUs 165) via a CU 160 (e.g., the CU 160-b for intra-cell LTM, the CU 160-c for inter-cell LTM, a candidate CU 160 associated with a candidate DU 165).

In some examples, the source DU 165-b may output a SP CSI-RS resource activation/deactivation message to the target DU 165-c. For example, in examples in which the source DU 165-b is associated with a different CU 160 as the target DU 165-c, the source DU 165-b may output the SP CSI-RS resource activation/deactivation message to the CU 160-b, and the CU 160-b may output the SP CSI-RS resource activation/deactivation message to the CU 160-c (e.g., for forwarding to the DU 165-c). In examples in which the source DU 165-b is associated with a same CU 160 as the target DU 165-c, the DU 165-b may output the SP CSI-RS resource activation/deactivation message to the CU 160 for forwarding to the DU 165-c. The SP CSI-RS resource activation/deactivation message may indicate one or more TCI state IDs, SP CSI-RS resource IDs, or both. As described herein, an SP CSI-RS resource ID may refer to an index of an NZP-CSI-RS resource ID or an index of an NZP-CSI-RS resource set ID. A TCI state ID may refer to an SSB index or an NZP-CSI-RS resource ID.

In some examples, the SP CSI-RS resource ID information may be a list of candidate CSI-RS resources to activate, and the DU 165-c may assign a different SP CSI-RS ID from the indicated candidate CSI-RS resources for the UE 115-b. Additionally, or alternatively, if the SP CSI-RS resource activation/deactivation message does not include SP CSI-RS resource IDs, the DU 165-c may select SP CSI-RS resources to activate based on the TCI state IDs.

In some examples, as described with reference to FIG. 4, the target DU 165-c (e.g., or the target CU 160-d) may determine to update one or more CSI-RS resources activated at the UE 115-b following the LTM cell switch. For example, based on receiving the activation status information from the DU 165-b and/or based on L1 or L3 measurement results from the UE 115-b, the DU 165-c (e.g., or the CU 160-c) may determine a list of SP CSI-RS resources to be activated for the UE 115-b following the LTM cell switch. The CU 160-c may output a final decision (e.g., determination) of the list of CSI-RS resources to be activated and/or deactivated (e.g., and/or TCI state information associated with the SP CSI-RS resources to be activated and/or deactivated) to the source DU 165-b (e.g., and/or one or more candidate DUs 165) via a CU 160 (e.g., the CU 160-c for intra-cell LTM, the CU 160-b for inter-cell LTM, a candidate CU 160 associated with a candidate DU 165). In some examples (e.g., if the UE 115-b is configured to conditionally activate CSI-RS resources based on one or more rules), the DU 165-c and/or the CU 160-c may use a same one or more rules to determine the list of CSI-RS resources to be activated and/or deactivated (e.g., and/or TCI state information associated with the SP CSI-RS resources to be activated and/or deactivated).

In some examples, the target DU 165-c may output a SP CSI-RS resource activation/deactivation message to the source DU 165-b. For example, in examples in which the source DU 165-b is associated with a different CU 160 as the target DU 165-c, the target DU 165-c may output the SP CSI-RS resource activation/deactivation message to the CU 160-c, and the CU 160-c may output the SP CSI-RS resource activation/deactivation message to the CU 160-b (e.g., for forwarding to the DU 165-b). In examples in which the source DU 165-b is associated with a same CU 160 as the target DU 165-c, the DU 165-c may output the SP CSI-RS resource activation/deactivation message to the CU 160 for forwarding to the DU 165-b. The SP CSI-RS resource activation/deactivation message may indicate one or more TCI state IDs, SP CSI-RS resource IDs, or any combination thereof.

FIG. 4 shows an example of a process flow 400 that supports CSI-RS resource management for LTM. The process flow 400 may implement or may be implemented by aspects of the wireless communication system 100, the network architecture 200, or the signaling configuration 300. For example, the process flow 400 may be implemented by a UE 115 (e.g., a UE 115-c) or one or more network entities 105 (e.g., a DU 165-d, a DU 165-e, a CU 160-d, a CU 160-e), which may be examples of the corresponding devices as described with reference to FIG. 1.

In the following description of the process flow 400, the operations between the UE 115-c, the DU 165-d, the DU 165-e, the CU 160-d, and the CU 160-e may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time. In some examples, the CU 160-e and the CU 160-d may be a same CU 160.

At 405, the DU 165-d, the DU 165-e, the CU 160-d, and the CU 160-e may perform an LTM preparation procedure. That is, the DU 165-d, the DU 165-e, the CU 160-d, and the CU 160-e may prepare roam the UE 115-c from the DU 165-d (e.g., a source DU) to the DU 165-e (e.g., a target DU). In some examples, at 410, the UE 115-c may receive a control message (e.g., an RRC reconfiguration message) indicating an LTM configuration and/or a CSI-RS resource and reporting configuration. The CSI-RS resource and reporting configuration may indicate a pre-cell switch activation status (e.g., one or more activated CSI-RS resources).

In some examples, at 415, the UE 115-c may output an RRC measurement report indicating one or more measurement results (e.g., beam measurements) to the CU 160-d (e.g., a serving CU 160). At 420, the CU 160-d may output an SP CSI-RS activation/deactivation message to the DU 165-d (e.g., for forwarding to the UE 115-c), to the CU 160-e (e.g., a target CU 160) for forwarding to the DU 165-e, and/or directly to the DU 165-e (e.g., if the DU 165-e is associated with the CU 160-d).

At 425, the DU 165-d may determine for the UE 115-c to perform an LTM cell switch to roam to the DU 165-e (e.g., based on the measurement reports). At 430, the DU 165-d may accordingly output a cell switch command (CSC) message to the UE 115-c indicating for the UE 115-c to switch to the DU 165-e.

In some examples, at 435 (e.g., after sending the CSC to the UE 115-c), the DU 165-d may indicate a pre-cell switch activation/deactivation status of one or more CSI-RS resources (e.g., via an LTM cell switch notification, such as an F1-AP Cell Switch Notification Message to the CU 160-d). In some examples, the indication of the pre-cell switch activation status may include an indication of one or more CSI-RS resource IDs corresponding to one or more activated CSI-RSs, one or more TCI state IDs corresponding to the one or more activated CSI-RSs, one or more CSI-RS resource IDs corresponding to one or more deactivated CSI-RSs, and/or one or more TCI states corresponding to the one or more deactivated CSI-RSs. The CU 160-d may output the pre-cell switch activation/deactivation status of the one or more SP CSI-RS resources to the CU 160-e (e.g., via an Xn-AP cell switch notification message) for forwarding to the DU 165-e via an F1-AP message). Additionally, or alternatively, if the DU 165-d and the DU 165-e are associated with a same CU 160-d, the CU 160-d may output the F1-AP message to the DU 165-e (e.g., without outputting an Xn-AP cell switch notification message). In some examples, the LTM cell switch notification may indicate the one or more measurement results from the UE 115-c.

At 440, the DU 165-e may determine post-cell switch activation status information by determining whether to activate or deactivate one or more SP CSI-RS resources of one or more candidate cells (e.g., via coordination with the one or more candidate cells and based on the pre-cell switch activation status information and/or the one or more measurement results) following the LTM cell switch. The post-cell switch activation status information may refer to a status (e.g., activation, deactivation) of one or more respective resources (e.g., CSI-RS resources or the like) that may be configured for the UE 115-b after completion of a cell switch (e.g., an LTM-based cell switch). For example, the DU 165-e may determine the post-cell switch activation status information based on selecting respective sets of the one or more CSI-RS resource sets to activate or deactivate for the UE 115-c. In some examples, selecting the respective sets of CSI-RS resources may be in accordance with one or more activation criteria.

At 445, the DU 165-e may output a CSI-RS activation/deactivation message to the UE 115-c (e.g., via a control message such as MAC-CE) that indicates the determined post-cell switch activation status. In some examples, the DU 165-e may output one or more control messages indicating the determined post-cell switch activation status to the DU 165-d (e.g., via the CU 160-d, the CU 160-e, or both), to one or more candidate DUs 165, or both. In some examples, the indication of the post-cell switch activation status may include an indication of one or more CSI-RS resource IDs corresponding to one or more activated CSI-RSs, one or more TCI state IDs corresponding to the one or more activated CSI-RSs, one or more CSI-RS resource IDs corresponding to one or more deactivated CSI-RSs, and/or one or more TCI states corresponding to the one or more deactivated CSI-RSs.

At 450, the DU 165-e may output (e.g., and the UE 115-c may monitor for) one or more CSI-RSs in accordance with the indicated post-cell switch activation status. The UE 115-c may accordingly perform CSI-RS measurements following the LTM cell switch, which may increase a reliability of communications for the UE 115-c.

FIG. 5 shows an example of a process flow 500 that supports CSI-RS resource management for LTM. The process flow 500 may implement or may be implemented by aspects of the wireless communication system 100, the network architecture 200, the signaling configuration 300, or the process flow 400. For example, the process flow 500 may be implemented by a UE 115 (e.g., a UE 115-d) or one or more network entities 105 (e.g., a DU 165-f, a DU 165-g, a CU 160-f, a CU 160-g), which may be examples of the corresponding devices as described with reference to FIG. 1.

In the following description of the process flow 500, the operations between the UE 115-d, the DU 165-f, the DU 165-g, the CU 160-f, and the CU 160-g may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time. In some examples, the CU 160-f and the CU 160-g may be a same CU 160.

At 505, the DU 165-f, the DU 165-g, the CU 160-f, and the CU 160-g may perform an LTM preparation procedure. That is, the DU 165-f, the DU 165-g, the CU 160-f, and the CU 160-g may prepare roam the UE 115-d from the DU 165-f (e.g., a source DU) to the DU 165-g (e.g., a target DU). In some examples, at 510, the UE 115-d may receive a control message (e.g., an RRC reconfiguration message) indicating an LTM configuration and/or a CSI-RS resource and reporting configuration. The CSI-RS resource and reporting configuration may indicate a pre-cell switch activation status (e.g., one or more activated CSI-RS resources).

In some examples, at 515, the UE 115-d may output an RRC measurement report indicating one or more measurement results (e.g., beam measurements) to the CU 160-f (e.g., a serving CU 160). At 520, the CU 160-f may output an SP CSI-RS activation/deactivation message to the DU 165-f (e.g., for forwarding to the UE 115-d), to the CU 160-g (e.g., a target CU 160) for forwarding to the DU 165-g, and/or directly to the DU 165-g (e.g., if the DU 165-g is associated with the CU 160-f).

At 525, the DU 165-f may determine for the UE 115-d to perform an LTM cell switch to roam to the DU 165-g (e.g., based on the measurement reports). At 530, the DU 165-f may accordingly output a CSC message to the UE 115-d indicating for the UE 115-d to switch to the DU 165-g.

In some examples, at 535 (e.g., after sending the CSC to the UE 115-d), the DU 165-f may determine post-cell switch activation status information by determining whether to activate or deactivate one or more SP CSI-RS resources of one or more candidate cells (e.g., via coordination with the one or more candidate cells and based on the one or more measurement results) following the LTM cell switch. For example, the DU 165-f may determine the post-cell switch activation status information based on selecting respective sets of the one or more CSI-RS resource sets to activate or deactivate for the UE 115-d. In some examples, selecting the respective sets of CSI-RS resources may be in accordance with one or more activation criteria.

At 540, the DU 165-f may indicate a pre-cell switch activation/deactivation status and/or the post-cell switch activation status of one or more CSI-RS resources (e.g., via an LTM cell switch notification, such as an F1-AP Cell Switch Notification Message to the CU 160-f). In some examples, the indication of the pre- and/or post-cell switch activation status may include an indication of one or more CSI-RS resource IDs corresponding to one or more activated CSI-RSs, one or more TCI state IDs corresponding to the one or more activated CSI-RSs, one or more CSI-RS resource IDs corresponding to one or more deactivated CSI-RSs, and/or one or more TCI states corresponding to the one or more deactivated CSI-RSs.

The CU 160-f may output the pre-cell switch activation/deactivation status of the one or more SP CSI-RS resources to the CU 160-g (e.g., via an Xn-AP cell switch notification message) for forwarding to the DU 165-g via an F1-AP message). Additionally, or alternatively, if the DU 165-f and the DU 165-g are associated with a same CU 160-f, the CU 160-f may output the F1-AP message to the DU 165-g (e.g., without outputting an Xn-AP cell switch notification message). In some examples, the LTM cell switch notification may indicate the one or more measurement results from the UE 115-d.

At 545, the DU 165-g may output a CSI-RS activation/deactivation message to the UE 115-d (e.g., via a control message such as MAC-CE) that indicates the determined post-cell switch activation status. In some examples, the DU 165-g may output one or more control messages indicating the determined post-cell switch activation status to one or more candidate DUs 165. In some examples, the indication of the post-cell switch activation status may include an indication of one or more CSI-RS resource IDs corresponding to one or more activated CSI-RSs, one or more TCI state IDs corresponding to the one or more activated CSI-RSs, one or more CSI-RS resource IDs corresponding to one or more deactivated CSI-RSs, and/or one or more TCI states corresponding to the one or more deactivated CSI-RSs.

At 550, the DU 165-g may output (e.g., and the UE 115-d may monitor for) one or more CSI-RSs in accordance with the indicated post-cell switch activation status. The UE 115-d may accordingly perform CSI-RS measurements following the LTM cell switch, which may increase a reliability of communications for the UE 115-d.

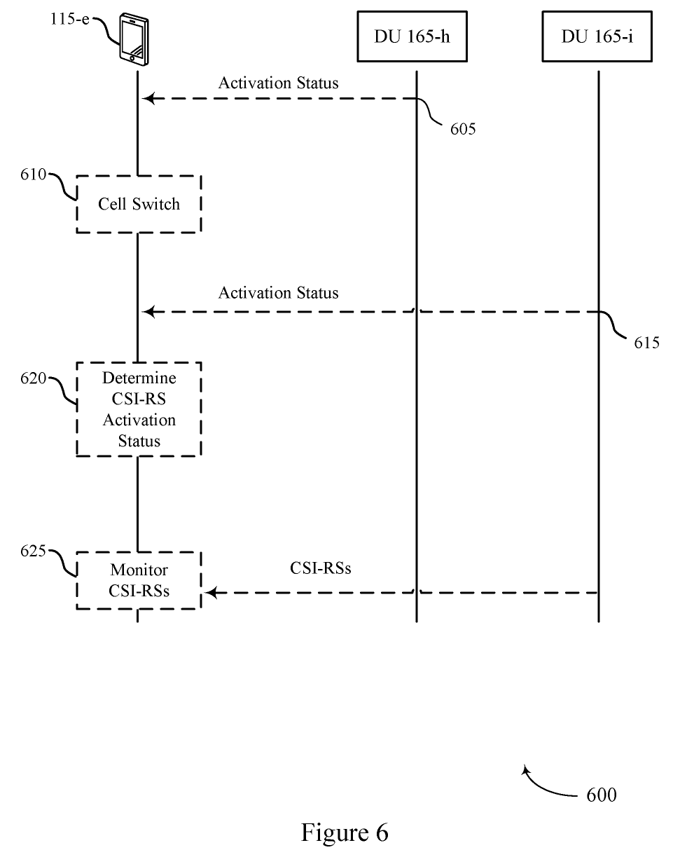

FIG. 6 shows an example of a process flow 600 that supports CSI-RS resource management for LTM. The process flow 400 may implement or may be implemented by aspects of the wireless communication system 100, the network architecture 200, the signaling configuration 300, the process flow 400, or the process flow 500. For example, the process flow 600 may be implemented by a UE 115 (e.g., a UE 115-e) or one or more network entities 105 (e.g., a DU 165-h, a DU 165-i), which may be examples of the corresponding devices as described with reference to FIG. 1.

In the following description of the process flow 600, the operations between the UE 115-e, the DU 165-h, and the DU 165-i may occur in a different order than the example order shown and, in some examples, may be performed by one or more different devices other than those shown as examples. Some operations also may be omitted from the process flow 600, and other operations may be added to the process flow 600. Further, although some operations or signaling may be shown to occur at different times for discussion purposes, these operations may actually occur at the same time.

In some examples, at 605, the UE 115-e may receive an indication of a post-cell switch (e.g., LTM cell switch) activation status for a set of CSI-RS resources. For example, the UE 115-e may receive the indication of the post-cell switch activation status via one or more control messages (e.g., MAC-CE messages, RRC messages) from a source DU 165-h. The one or more control messages may indicate CSI-RS resources for the UE 115-e to activate or to keep activated following the LTM cell switch, CSI-RS resources for the UE 115-e to deactivate or to keep deactivated following the LTM cell switch, or any combination thereof. The indication of the CSI-RS resources may be indications of IDs corresponding to LTM CSI resources, CSI-RS resource sets, CSI-RS IDs, and/or TCI states corresponding to CSI-RS resources. The one or more MAC-CE messages may include an LTM cell switch command indicating for the UE 115-e to switch from the source DU 165-h to the target DU 165-i.

At 610, the UE 115-e may perform the LTM cell switch (e.g., in response to receiving the indication to switch from the source DU 165-h to the target DU 165-i). For example, the UE 115-e may receive the indication from the DU 165-h in response to one or more measurement reports from the UE 115-e as described herein. In some examples, the LTM cell switch may be an inter-cell switch (e.g., if the DU 165-i is associated with a different CU 160 than the DU 165-h) or an intra-cell switch (e.g., if the DU 165-i is associated with a same CU 160 as the DU 165-h).

In some examples, at 615, the UE 115-e may receive an indication of the post-cell switch (e.g., LTM cell switch) activation status for the set of CSI-RS resources. For example, the UE 115-e may receive the indication of the post-cell switch activation status via one or more control messages (e.g., MAC-CE messages, RRC messages) from the target DU 165-i. The one or more control messages may indicate CSI-RS resources for the UE 115-e to activate or to keep activated following the LTM cell switch, CSI-RS resources for the UE 115-e to deactivate or to keep deactivated following the LTM cell switch, or any combination thereof. The indication of the CSI-RS resources may be indications of IDs corresponding to LTM CSI resources, CSI-RS resource sets, CSI-RS IDs, and/or TCI states corresponding to CSI-RS resources.

At 620, the UE 115-e may determine the post-cell switch activation status of the CSI-RS resources. In some examples, the UE 115-e may determine the activation status based on receiving the indication from the DU 165-h or the DU 165-i. Additionally, or alternatively, the UE 115-e may determine the activation status based on an absence of the indication of the post-cell switch activation status (e.g., according to a default activation status). Additionally, or alternatively, the UE 115-e may determine the activation status based on one or more activation rules. For example, the UE 115-e may determine the one or more activation rules based on receiving control signaling (e.g., RRC or MAC-CE signaling from the DU 165-h or the DU 165-i) or based on a rule defined in a technical specification.

In some examples, the one or more activation rules may indicate for the UE 115-e to maintain a pre-cell switch activation status for the set of CSI-RS resources. That is, the one or more activation rules may indicate for the UE 115-e to keep active one or more CSI-RS resources that are active at the DU 165-h prior to the LTM cell switch. Additionally, or alternatively, the one or more activation rules may indicate for the UE 115-e to deactivate all CSI-RS resources that are active at the DU 165-h prior to the LTM cell switch (e.g., and to receive control signaling, such as a MAC-CE, from the DU 165-i indicating for the UE 115-e to activate one or more CSI-RS resources following the cell switch). Additionally, or alternatively, the one or more activation rules may indicate for the UE 115-e to activate one or more LTM CSI resources corresponding to a previously-activated set of CSI-RS resources (e.g., if one or all of the set of CSI-RS resources are activated). Additionally, or alternatively, the one or more activation rules may indicate for the UE 115-e to selectively activate one or more of the set of CSI-RS resources in accordance with a type of resource corresponding to each of the set of CSI-RS resources, an LTM execution condition corresponding to each of the set of CSI-RS resources, a frequency band corresponding to each of the set of CSI-RS resources, an LTM CSI resource corresponding to each of the set of CSI-RS resources, or any combination thereof.

In some examples, at 625, the UE 115-e may monitor for one or more CSI-RSs from the DU 165-i in via one or more activate CSI-RS resources (e.g., in accordance with the determined activation status and/or in accordance with receiving an indication from the DU 165-I to activate the one or more CSI-RS resources). The UE 115-e may accordingly perform beam management based on measurements of the CSI-RSs, which may improve a reliability of communications with the DU 165-i.

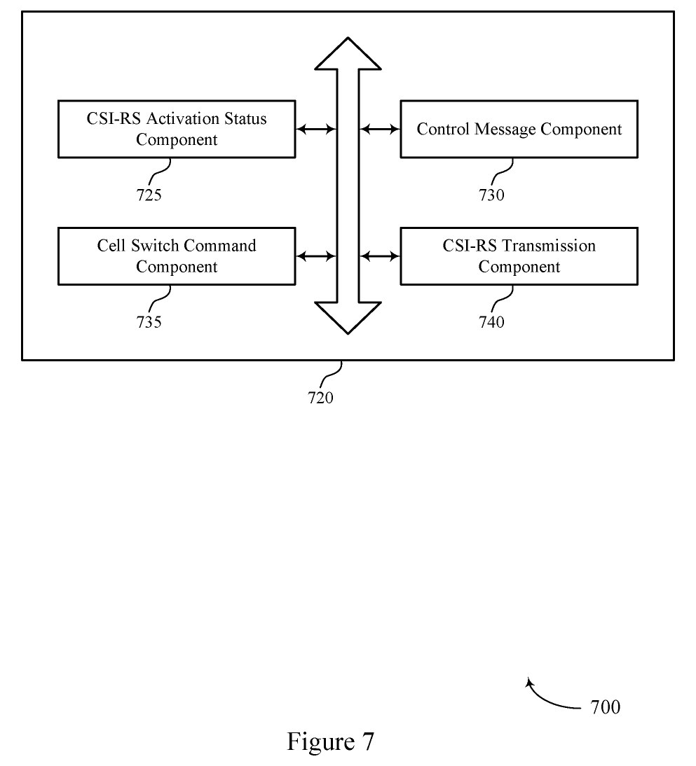

FIG. 7 shows an example 700 of a processing system 720 that supports CSI-RS resource management for LTM. A processing system 720 may be an example of a processing system 145 (such as network entity 105) and may include a CSI-RS activation status component 725, a control message component 730, a cell switch command component 735, a CSI-RS transmission component 740, or any combination thereof. A processing system 720, or various component thereof, may be an example of means for performing (such as a means for causing a network entity 105 to perform) various techniques described herein.

The CSI-RS activation status component 725 may be configured to cause the network entity 105 to obtain an LTM cell switch notification message including an indication of a pre-cell switch activation status of one or more CSI-RS resources at a UE. In some examples, the CSI-RS activation status component 725 may be configured to cause the network entity 105 to determine a post-cell switch activation status of each of the one or more CSI-RS resources based on the pre-cell switch activation status. The control message component 730 may be configured to cause the network entity 105 to output one or more control messages including an indication of the post-cell switch activation status.

In some examples, to support determining the post-cell switch activation status, the CSI-RS activation status component 725 may be configured to cause the network entity 105 to select respective sets of the one or more CSI-RS resources to activate or deactivate for the UE based on the pre-cell switch activation status.

In some examples, the CSI-RS activation status component 725 may be configured to cause the network entity 105 to receive, via the LTM cell switch notification message, an indication of one or more measurement results corresponding to a set of measurements of one or more CSI-RSs, where selecting the respective sets of the one or more CSI-RS resources is based on the one or more measurement results and the pre-cell switch activation status. In some examples, selecting the respective sets of the one or more CSI-RS resources is in accordance with one or more activation criteria.

In some examples, to support outputting the one or more control messages, the control message component 730 may be configured to cause the network entity 105 to output the one or more control messages to one or more second network entities.

In some examples, the one or more second network entities are associated with a source cell prior to an LTM cell switch, a candidate cell for the LTM cell switch, or any combination thereof.

In some examples, to support outputting the one or more control messages, the control message component 730 may be configured to cause the network entity 105 to output the one or more control messages to the UE.

In some examples, the CSI-RS transmission component 740 may be configured to cause the network entity 105 to output a set of CSI-RSs via the one or more CSI-RS resources to the UE in accordance with the post-cell switch activation status.

In some examples, the indication of the post-cell switch activation status includes an indication of one or more CSI-RS resource identifiers corresponding to one or more activated CSI-RSs, one or more transmission configuration indicator state identifiers corresponding to the one or more activated CSI-RSs, one or more CSI-RS resource identifiers corresponding to one or more deactivated CSI-RSs, one or more transmission configuration indicator states corresponding to the one or more deactivated CSI-RSs, or any combination thereof.

In some examples, the indication of the pre-cell switch activation status includes an indication of one or more CSI-RS resource identifiers corresponding to one or more activated CSI-RSs, one or more transmission configuration indicator state identifiers corresponding to the one or more activated CSI-RSs, one or more CSI-RS resource identifiers corresponding to one or more deactivated CSI-RSs, one or more transmission configuration indicator states corresponding to the one or more deactivated CSI-RSs, or any combination thereof.

In some examples, the LTM cell switch notification message is obtained via an F1-AP interface. In some examples, the LTM cell switch notification message is obtained via an Xn-AP interface.

Additionally, or alternatively, the cell switch command component 735 may be configured to cause the network entity 105 to output an LTM cell switch command. In some examples, the CSI-RS activation status component 725 may be configured to cause the network entity 105 to determine a post-cell switch activation status of each of one or more CSI-RS resources at a UE associated with the LTM cell switch command, where the post-cell switch activation status is based on a pre-cell switch activation status of the one or more CSI-RS resources at the UE. In some examples, the CSI-RS activation status component 725 may be configured to cause the network entity 105 to output, based on the LTM cell switch command, an LTM cell switch notification message including an indication of the post-cell switch activation status of each of the one or more CSI-RS resources.

In some examples, the CSI-RS activation status component 725 may be configured to cause the network entity 105 to output, via the LTM cell switch notification message, an indication of the pre-cell switch activation status of the one or more CSI-RS resources.

In some examples, the indication of the pre-cell switch activation status includes an indication of one or more CSI-RS resource identifiers corresponding to one or more activated CSI-RS resources, one or more transmission configuration indicator state identifiers corresponding to the one or more activated CSI-RS resources, one or more CSI-RS resource identifiers corresponding to one or more deactivated CSI-RS resources, one or more transmission configuration indicator states corresponding to the one or more deactivated CSI-RS resources, or any combination thereof.

In some examples, to support determining the post-cell switch activation status, the CSI-RS activation status component 725 may be configured to cause the network entity 105 to select respective sets of the one or more CSI-RS resources to activate or deactivate for the UE based on the pre-cell switch activation status.

In some examples, the CSI-RS activation status component 725 may be configured to cause the network entity 105 to obtain one or more measurement reports indicating a set of measurements of one or more CSI-RSs, where selecting the respective sets of the one or more CSI-RS resources is based on the set of measurements and the pre-cell switch activation status.

In some examples, the indication of the post-cell switch activation status includes an indication of one or more CSI-RS resource identifiers corresponding to one or more activated CSI-RS resources, one or more transmission configuration indicator state identifiers corresponding to the one or more activated CSI-RS resources, one or more CSI-RS resource identifiers corresponding to one or more deactivated CSI-RS resources, one or more transmission configuration indicator states corresponding to the one or more deactivated CSI-RS resources, or any combination thereof.

In some examples, the LTM cell switch notification message is output via an F1-AP interface. In some examples, the LTM cell switch notification message is output via an Xn-AP interface.

A processing system 720 may include or be an example of one or more chips, SoCs, chipsets, packages, components, or devices that individually or collectively constitute or include a processing system. A processing system 720 may interface with other components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 720 for operation in a processing system 720 as described herein, the processing system 720 may support techniques for activation of CSI-RS resources for LTM, which may enable improved communication reliability, reduced latency, and improved coordination between devices.

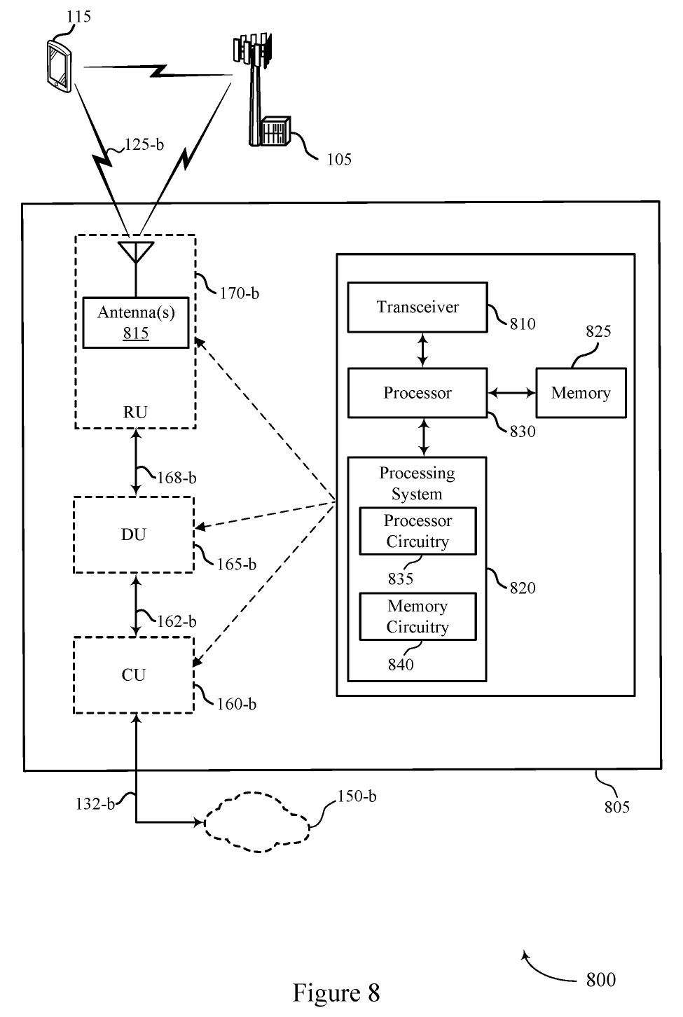

FIG. 8 shows an example of a system 800 including a device 805 that supports CSI-RS resource management for LTM. The device 805 may communicate (such as via one or more wired interfaces or one or more wireless interfaces) with other network devices or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or any combination thereof, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830 (e.g., directly, indirectly, without pre-processing, after pre-processing), cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 720. For example, the processing system 820 may include processor circuitry 835 and memory circuitry 840 that stores code, and the processing system 820 may be configured to cause the device 805 to perform operations that support CSI-RS resource management for LTM. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for activation of CSI-RS resources for LTM, which may enable improved communication reliability, reduced latency, and improved coordination between devices.

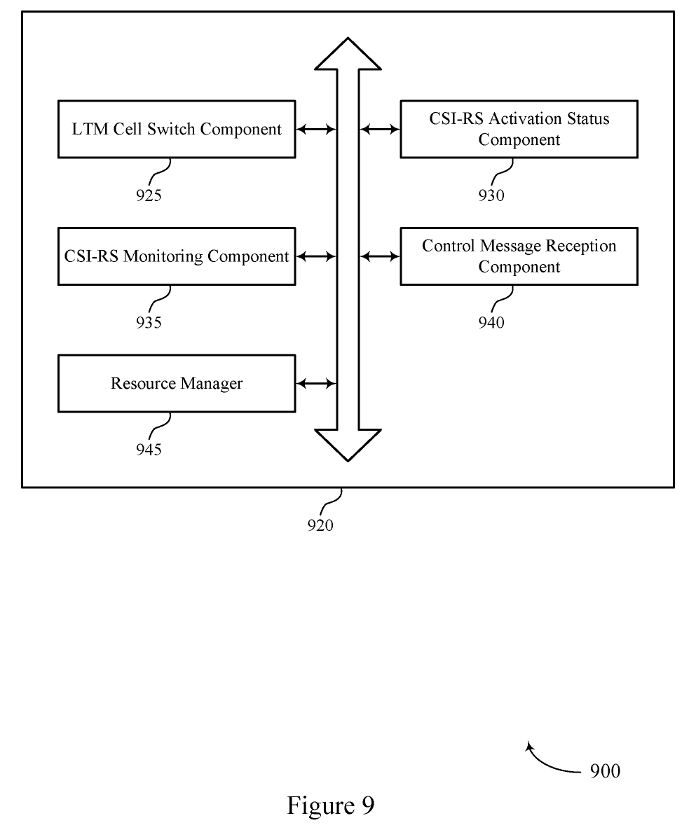

FIG. 9 shows an example 900 of a processing system 920 that supports CSI-RS resource management for LTM. A processing system 920 may be an example of a processing system 140 (such as of a UE 115) and may include an LTM cell switch component 925, a CSI-RS activation status component 930, a CSI-RS monitoring component 935, a control message reception component 940, a resource manager 945, or any combination thereof. A processing system 920, or various component thereof, may be an example of means for performing (such as a means for causing a UE 115 to perform) various techniques described herein.

The LTM cell switch component 925 may be configured to cause the UE 115 to perform an LTM cell switch from a source cell to a target cell. The CSI-RS activation status component 930 may be configured to cause the UE 115 to determine, in accordance with an indication of a post-cell switch activation status for a set of CSI-RS resources, which CSI-RS resources of the set of CSI-RS resources are to be activated or deactivated after the LTM cell switch. The CSI-RS monitoring component 935 may be configured to cause the UE 115 to monitor for one or more CSI-RSs via one or more of the set of CSI-RS resources in accordance with the post-cell switch activation status.

In some examples, the CSI-RS activation status component 930 may be configured to cause the UE 115 to receive one or more control messages including the indication of the post-cell switch activation status, where determining which CSI-RS resources are to be activated or deactivated is in accordance with the post-cell switch activation status. In some examples, the indication of the post-cell switch activation status includes an indication of LTM channel state information resources, CSI-RS resource sets, CSI-RS resource identifiers, or any combination thereof.

In some examples, the one or more control messages include one or more radio resource control messages indicating one or more CSI-RS resources to remain activated after the LTM cell switch, one or more CSI-RS resources to activate after the LTM cell switch, one or more CSI-RS resources to remain deactivated after the LTM cell switch, one or more CSI-RS resources to deactivate after the LTM cell switch, or any combination thereof.

In some examples, the one or more control messages include one or more medium access control-control elements indicating one or more CSI-RS resources to remain activated after the LTM cell switch, one or more CSI-RS resources to activate after the LTM cell switch, one or more CSI-RS resources to remain deactivated after the LTM cell switch, one or more CSI-RS resources to deactivate after the LTM cell switch, or any combination thereof.

In some examples, the one or more medium access control-control elements include an LTM cell switch command. In some examples, performing the LTM cell switch is in accordance with the LTM cell switch command.

In some examples, the LTM cell switch component 925 may be configured to cause the UE 115 to perform a second LTM cell switch from a second source cell to a second target cell. In some examples, the CSI-RS activation status component 930 may be configured to cause the UE 115 to determine which CSI-RS resources of the set of CSI-RS resources are to be activated or deactivated after the second LTM cell switch, where determining which CSI-RS resources of the set of CSI-RS resources are to be activated or deactivated is in accordance with an absence of the indication of the post-cell switch activation status.

In some examples, the LTM cell switch component 925 may be configured to cause the UE 115 to perform an LTM cell switch from a source cell to a target cell. In some examples, the CSI-RS activation status component 930 may be configured to cause the UE 115 to determine, in accordance with one or more activation rules that indicate a post-cell switch activation status for a set of CSI-RS resources, which CSI-RS resources of the set of CSI-RS resources are to be activated or deactivated after the LTM cell switch. In some examples, the CSI-RS monitoring component 935 may be configured to cause the UE 115 to monitor for one or more CSI-RSs via one or more of the set of CSI-RS resources in accordance with the post-cell switch activation status.

In some examples, the one or more activation rules indicate that the UE is to maintain a pre-cell switch activation status corresponding to the set of CSI-RS resources. In some examples, the one or more activation rules indicate that the UE is to activate one or more LTM channel state information resources corresponding to at least one previously activated set of CSI-RS resources. In some examples, the one or more activation rules indicate that the UE is to activate one or more LTM channel state information resources corresponding to each previously activated set of CSI-RS resources. In some examples, the one or more activation rules indicate for the UE to deactivate the set of CSI-RS resources.

In some examples, the resource manager 945 may be configured to cause the UE 115 to receive one or more control messages indicating for the UE to activate one or more of the set of CSI-RS resources, where monitoring for the one or more CSI-RSs is in accordance with the one or more control messages.

In some examples, the one or more activation rules indicate for the UE to selectively activate one or more of the set of CSI-RS resources in accordance with a type of resource corresponding to each of the set of CSI-RS resources, an LTM execution condition corresponding to each of the set of CSI-RS resources, a frequency band corresponding to each of the set of CSI-RS resources, an LTM channel state information resource corresponding to each of the set of CSI-RS resources, or any combination thereof.

In some examples, the control message reception component 940 may be configured to cause the UE 115 to receive one or more control messages indicating the one or more activation rules.

A processing system 920 may include or be a component of one or more chips, systems-on-chips (SoCs), chipsets, packages, components, or devices that individually or collectively constitute or include a processing system. A processing system 920 may interface with other components of a processing system 920. For example, operations described with reference to a processing system 920, or various components thereof, may be performed by or with other such components, including a receiver, a transmitter, a transceiver, a modem, a user interface, a modulator/demodulator, an encoder/decoder, or any combination thereof (such as of the processing system 920, coupled with the processing system 920, of a processing system 920).

By including or configuring a processing system 920 for operation in a processing system 920 as described herein, the processing system 920 may support techniques for activation of CSI-RS resources for LTM, which may enable improved communication reliability, reduced latency, and improved coordination between devices.

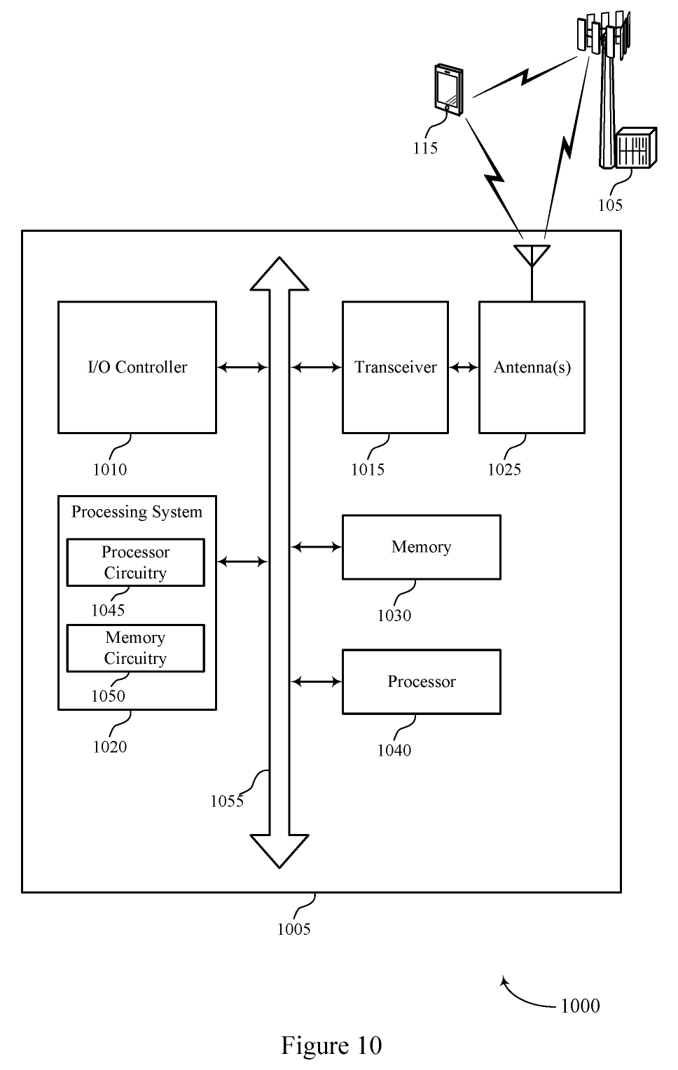

FIG. 10 shows an example of a system 1000 including a device 1005 that supports CSI-RS resource management for LTM. The device 1005 may be an example of or include components of UE 115. The device 1005 may communicate (such as wirelessly) with one or more other devices (such as network entities 105, UEs 115). The device 1005 may include components for transmitting and receiving communication, which may include a processing system 1020, an input/output (I/O) controller, such as an I/O controller 1010, a transceiver 1015, antenna(s) 1025, a memory 1030, and a processor 1040. Components of the device 1005 may be coupled (such as operatively, communicatively, functionally, electronically, electrically, in electronic communication) a bus 1055.

The transceiver 1015 may support bi-directional communication via antenna(s) 1025, and may support transmission operations, reception operations, or any combination thereof, as described herein. The transceiver 1015 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 1005). The transceiver 1015 may modulate symbols and provide the modulated symbols to antenna(s) 1025 for transmission, and demodulate symbols from signals received using antenna(s) 1025.

The processor 1040 may be a general-purpose processing component that supports various operations (such as applications) of the device 1005. The memory 1030 may be a general-purpose storage component that stores code executable by the processor 1040. Such code may include instructions that, when executed by the processor 1040 (e.g., directly, indirectly, without pre-processing, after pre-processing), cause the device 1005 to perform various functions (such as to support an application of the device 1005). The I/O controller 1010 may manage inputs and outputs for the device 1005, may manage peripherals not integrated into the device 1005, or may represent a physical connection (such as port) to an external peripheral. The processor 1040 may interact with a modem, a keyboard, a mouse, a touchscreen, or other device (such as via I/O controller 1010). In some implementations, a user may interact with the device 1005 via the I/O controller 1010 or via hardware components controlled by the I/O controller 1010.

The processing system 1020 may be an example of a processing system 140 or a processing system 920. For example, the processing system 1020 may include processor circuitry 1045 and memory circuitry 1050 that stores code, and may be configured to cause the device 1005 to perform operations that support CSI-RS resource management for LTM. Although the processing system 1020 is illustrated as a separate component, which may involve a separate chip, chipset, or other module, in some implementations, one or more functions described with reference to the processing system 1020 may be supported by or performed by a transceiver 1015, antenna(s) 1025, a processor 1040, memory 1030, or any combination thereof, such that a processing system 1020 may include one or more of a transceiver 1015, antenna(s) 1025, a processor 1040, memory 1030, or any combination thereof.

By including or configuring the processing system 1020 for operation in the device 1005 as described herein, may support techniques for activation of CSI-RS resources for LTM, which may enable improved communication reliability, reduced latency, and improved coordination between devices.

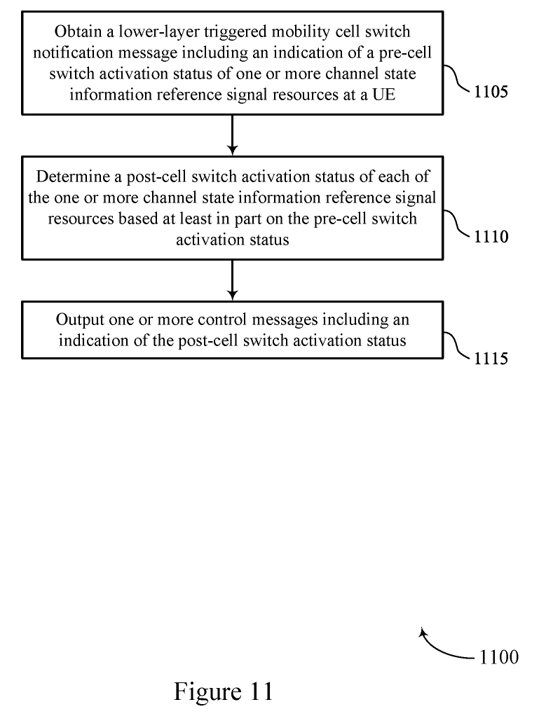

FIG. 11 shows an example of a method 1100 that supports CSI-RS resource management for LTM. Operations of the method 1100 may be performed by a network entity 105 or its components (such as using a processing system configured to cause the network entity to perform one or more operations) as described herein.

At 1105, the method may include obtaining an LTM cell switch notification message including an indication of a pre-cell switch activation status of one or more CSI-RS resources at a UE. In some examples, aspects of the operations of 1105 may be performed by a CSI-RS activation status component 725.

At 1110, the method may include determining a post-cell switch activation status of each of the one or more CSI-RS resources based at least in part on the pre-cell switch activation status. In some examples, aspects of the operations of 1110 may be performed by a CSI-RS activation status component 725.

At 1115, the method may include outputting one or more control messages including an indication of the post-cell switch activation status. In some examples, aspects of the operations of 1115 may be performed by a control message component 730.

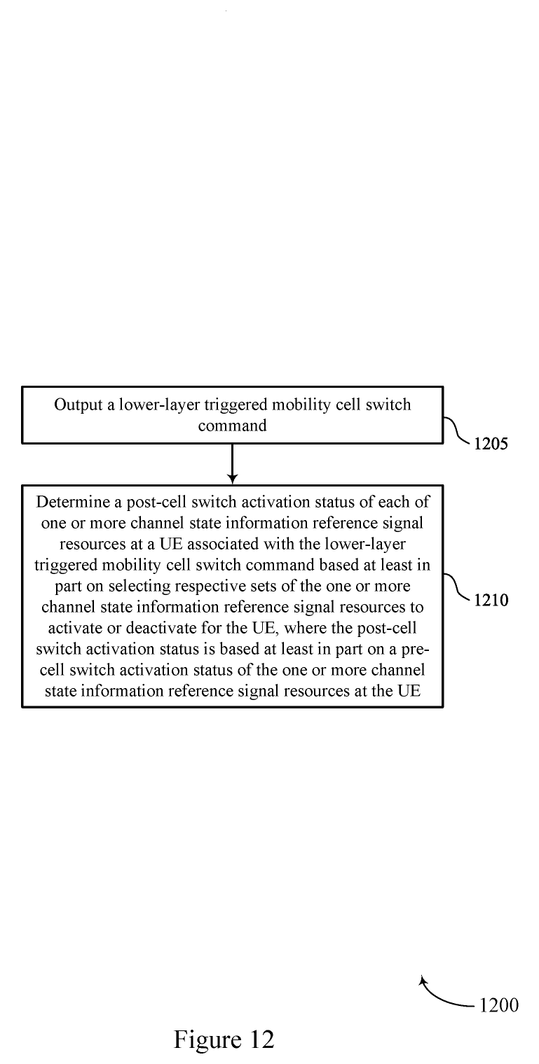

FIG. 12 shows an example of a method 1200 that supports CSI-RS resource management for LTM. Operations of the method 1200 may be performed by a network entity 105 or its components (such as using a processing system configured to cause the network entity to perform one or more operations) as described herein.

At 1205, the method may include outputting an LTM cell switch command. In some examples, aspects of the operations of 1205 may be performed by a cell switch command component 735.

At 1210, the method may include determining a post-cell switch activation status of each of one or more CSI-RS resources at a UE associated with the LTM cell switch command based at least in part on selecting respective sets of the one or more channel state information reference signal resources to activate or deactivate for the UE, where the post-cell switch activation status is based at least in part on a pre-cell switch activation status of the one or more CSI-RS resources at the UE. In some examples, aspects of the operations of 1210 may be performed by a CSI-RS activation status component 725.

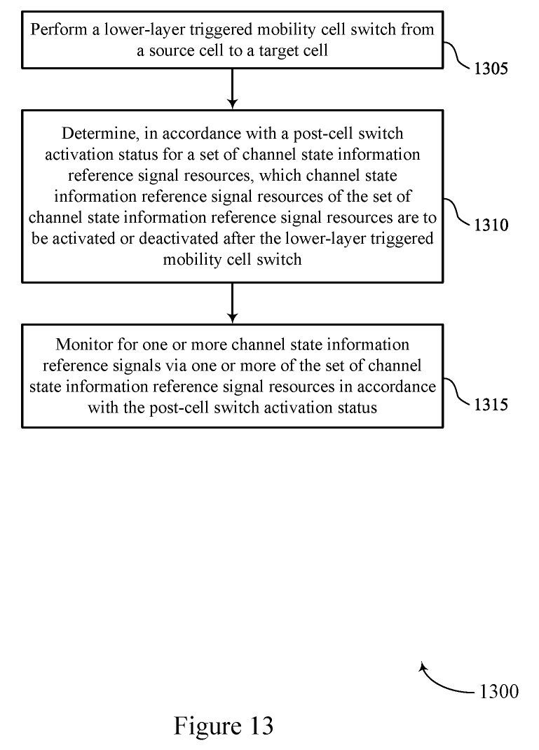

FIG. 13 shows an example of a method 1300 that supports CSI-RS resource management for LTM. Operations of the method 1300 may be performed by a UE or its components (such as using a processing system configured to cause the UE 115 to perform one or more of the operations) as described herein.

At 1305, the method may include performing an LTM cell switch from a source cell to a target cell. In some examples, aspects of the operations of 1305 may be performed by an LTM cell switch component 925.

At 1310, the method may include determining, in accordance with a post-cell switch activation status for a set of CSI-RS resources, which CSI-RS resources of the set of CSI-RS resources are to be activated or deactivated after the LTM cell switch. In some examples, aspects of the operations of 1310 may be performed by a CSI-RS activation status component 930.

At 1315, the method may include monitoring for one or more CSI-RSs via one or more of the set of CSI-RS resources in accordance with the post-cell switch activation status. In some examples, aspects of the operations of 1315 may be performed by a CSI-RS monitoring component 935.

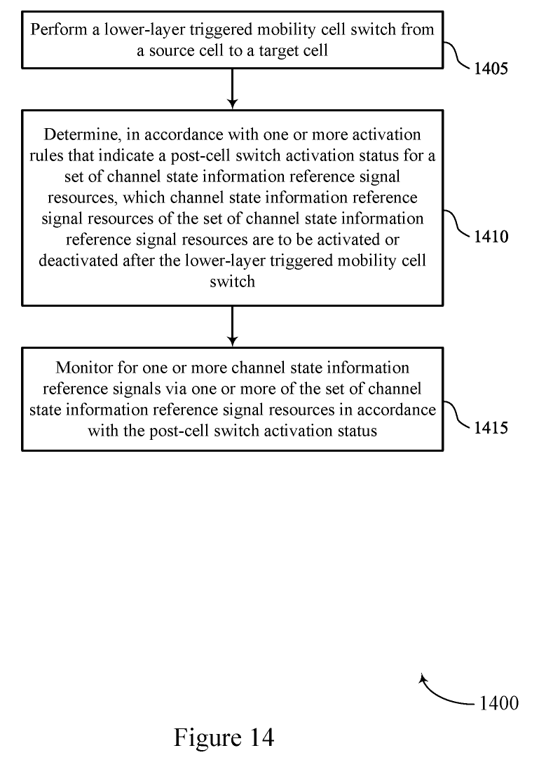

FIG. 14 shows an example of a method 1400 that supports CSI-RS resource management for LTM. Operations of the method 1400 may be performed by a UE or its components (such as using a processing system configured to cause the UE 115 to perform one or more of the operations) as described herein.

At 1405, the method may include performing an LTM cell switch from a source cell to a target cell. In some examples, aspects of the operations of 1405 may be performed by an LTM cell switch component 925.

At 1410, the method may include determining, in accordance with one or more activation rules that indicate a post-cell switch activation status for a set of CSI-RS resources, which CSI-RS resources of the set of CSI-RS resources are to be activated or deactivated after the LTM cell switch. In some examples, aspects of the operations of 1410 may be performed by a CSI-RS activation status component 930.

At 1415, the method may include monitoring for one or more CSI-RSs via one or more of the set of CSI-RS resources in accordance with the post-cell switch activation status. In some examples, aspects of the operations of 1415 may be performed by a CSI-RS monitoring component 935.

Implementation examples are described in the following numbered clauses:

Aspect 1: A method for wireless communications by a network entity, comprising: obtaining an LTM cell switch notification message comprising an indication of a pre-cell switch activation status of one or more CSI-RS resources at a UE; determining a post-cell switch activation status of each of the one or more CSI-RS resources based at least in part on the pre-cell switch activation status; and outputting one or more control messages comprising an indication of the post-cell switch activation status.

Aspect 2: The method of aspect 1, wherein determining the post-cell switch activation status comprises: selecting respective sets of the one or more CSI-RS resources to activate or deactivate for the UE based at least in part on the pre-cell switch activation status.

Aspect 3: The method of aspect 2, further comprising: receiving, via the LTM cell switch notification message, an indication of one or more measurement results corresponding to a set of measurements of one or more CSI-RSs, wherein selecting the respective sets of the one or more CSI-RS resources is based at least in part on the one or more measurement results and the pre-cell switch activation status.

Aspect 4: The method of any of aspects 2 through 3, wherein selecting the respective sets of the one or more CSI-RS resources is in accordance with one or more activation criteria.

Aspect 5: The method of any of aspects 1 through 4, wherein outputting the one or more control messages comprises: outputting the one or more control messages to one or more second network entities.

Aspect 6: The method of aspect 5, wherein the one or more second network entities are associated with a source cell prior to an LTM cell switch, a candidate cell for the LTM cell switch, or any combination thereof.

Aspect 7: The method of any of aspects 1 through 6, wherein outputting the one or more control messages comprises: outputting the one or more control messages to the UE.

Aspect 8: The method of aspect 7, further comprising: outputting a set of CSI-RSs via the one or more CSI-RS resources to the UE in accordance with the post-cell switch activation status.

Aspect 9: The method of any of aspects 1 through 8, wherein the indication of the post-cell switch activation status comprises an indication of one or more CSI-RS resource identifiers corresponding to one or more activated CSI-RSs, one or more transmission configuration indicator state identifiers corresponding to the one or more activated CSI-RSs, one or more CSI-RS resource identifiers corresponding to one or more deactivated CSI-RSs, one or more transmission configuration indicator states corresponding to the one or more deactivated CSI-RSs, or any combination thereof.

Aspect 10: The method of any of aspects 1 through 9, wherein the indication of the pre-cell switch activation status comprises an indication of one or more CSI-RS resource identifiers corresponding to one or more activated CSI-RSs, one or more transmission configuration indicator state identifiers corresponding to the one or more activated CSI-RSs, one or more CSI-RS resource identifiers corresponding to one or more deactivated CSI-RSs, one or more transmission configuration indicator states corresponding to the one or more deactivated CSI-RSs, or any combination thereof.

Aspect 11: The method of any of aspects 1 through 10, wherein the LTM cell switch notification message is obtained via an F1-AP interface.

Aspect 12: The method of any of aspects 1 through 11, wherein the LTM cell switch notification message is obtained via an Xn-AP interface.

Aspect 13: A method for wireless communications by a first network entity, comprising: outputting an LTM cell switch command; determining a post-cell switch activation status of each of one or more CSI-RS resources at a UE associated with the LTM cell switch command, wherein the post-cell switch activation status is based at least in part on a pre-cell switch activation status of the one or more CSI-RS resources at the UE; and outputting, based at least in part on the LTM cell switch command, an LTM cell switch notification message comprising an indication of the post-cell switch activation status of each of the one or more CSI-RS resources.

Aspect 14: The method of aspect 13, further comprising: outputting, via the LTM cell switch notification message, an indication of the pre-cell switch activation status of the one or more CSI-RS resources.

Aspect 15: The method of aspect 14, wherein the indication of the pre-cell switch activation status comprises an indication of one or more CSI-RS resource identifiers corresponding to one or more activated CSI-RS resources, one or more transmission configuration indicator state identifiers corresponding to the one or more activated CSI-RS resources, one or more CSI-RS resource identifiers corresponding to one or more deactivated CSI-RS resources, one or more transmission configuration indicator states corresponding to the one or more deactivated CSI-RS resources, or any combination thereof.

Aspect 16: The method of any of aspects 13 through 15, wherein determining the post-cell switch activation status comprises: selecting respective sets of the one or more CSI-RS resources to activate or deactivate for the UE based at least in part on the pre-cell switch activation status.

Aspect 17: The method of aspect 16, further comprising: obtaining one or more measurement reports indicating a set of measurements of one or more CSI-RSs, wherein selecting the respective sets of the one or more CSI-RS resources is based at least in part on the set of measurements and the pre-cell switch activation status.

Aspect 18: The method of any of aspects 13 through 17, wherein the indication of the post-cell switch activation status comprises an indication of one or more CSI-RS resource identifiers corresponding to one or more activated CSI-RS resources, one or more transmission configuration indicator state identifiers corresponding to the one or more activated CSI-RS resources, one or more CSI-RS resource identifiers corresponding to one or more deactivated CSI-RS resources, one or more transmission configuration indicator states corresponding to the one or more deactivated CSI-RS resources, or any combination thereof.

Aspect 19: The method of any of aspects 13 through 18, wherein the LTM cell switch notification message is output via an F1-AP interface.

Aspect 20: The method of any of aspects 13 through 19, wherein the LTM cell switch notification message is output via an Xn-AP interface.

Aspect 21: A method for wireless communications by a UE, comprising: performing an LTM cell switch from a source cell to a target cell; determining, in accordance with an indication of a post-cell switch activation status for a set of CSI-RS resources, which CSI-RS resources of the set of CSI-RS resources are to be activated or deactivated after the LTM cell switch; and monitoring for one or more CSI-RSs via one or more of the set of CSI-RS resources in accordance with the post-cell switch activation status.

Aspect 22: The method of aspect 21, further comprising: receiving one or more control messages comprising the indication of the post-cell switch activation status, wherein determining which CSI-RS resources are to be activated or deactivated is in accordance with the post-cell switch activation status.

Aspect 23: The method of aspect 22, wherein the indication of the post-cell switch activation status comprises an indication of LTM channel state information resources, CSI-RS resource sets, CSI-RS resource identifiers, or any combination thereof.

Aspect 24: The method of any of aspects 22 through 23, wherein the one or more control messages comprise one or more radio resource control messages indicating one or more CSI-RS resources to remain activated after the LTM cell switch, one or more CSI-RS resources to activate after the LTM cell switch, one or more CSI-RS resources to remain deactivated after the LTM cell switch, one or more CSI-RS resources to deactivate after the LTM cell switch, or any combination thereof.

Aspect 25: The method of any of aspects 22 through 24, wherein the one or more control messages comprise one or more medium access control-control elements indicating one or more CSI-RS resources to remain activated after the LTM cell switch, one or more CSI-RS resources to activate after the LTM cell switch, one or more CSI-RS resources to remain deactivated after the LTM cell switch, one or more CSI-RS resources to deactivate after the LTM cell switch, or any combination thereof.

Aspect 26: The method of aspect 25, wherein the one or more medium access control-control elements comprise an LTM cell switch command, and performing the LTM cell switch is in accordance with the LTM cell switch command.

Aspect 27: The method of any of aspects 21 through 26, further comprising: performing a second LTM cell switch from a second source cell to a second target cell; and determining which CSI-RS resources of the set of CSI-RS resources are to be activated or deactivated after the second LTM cell switch, wherein determining which CSI-RS resources of the set of CSI-RS resources are to be activated or deactivated is in accordance with an absence of the indication of the post-cell switch activation status.

Aspect 28: A method for wireless communications by a UE, comprising: performing an LTM cell switch from a source cell to a target cell; determining, in accordance with one or more activation rules that indicate a post-cell switch activation status for a set of CSI-RS resources, which CSI-RS resources of the set of CSI-RS resources are to be activated or deactivated after the LTM cell switch; and monitoring for one or more CSI-RSs via one or more of the set of CSI-RS resources in accordance with the post-cell switch activation status.

Aspect 29: The method of aspect 28, wherein the one or more activation rules indicate that the UE is to maintain a pre-cell switch activation status corresponding to the set of CSI-RS resources.

Aspect 30: The method of any of aspects 28 through 29, wherein the one or more activation rules indicate that the UE is to activate one or more LTM channel state information resources corresponding to at least one previously activated set of CSI-RS resources.

Aspect 31: The method of any of aspects 28 through 30, wherein the one or more activation rules indicate that the UE is to activate one or more LTM channel state information resources corresponding to each previously activated set of CSI-RS resources.

Aspect 32: The method of any of aspects 28 through 31, wherein the one or more activation rules indicate for the UE to deactivate the set of CSI-RS resources.

Aspect 33: The method of aspect 32, further comprising: receiving one or more control messages indicating for the UE to activate one or more of the set of CSI-RS resources, wherein monitoring for the one or more CSI-RSs is in accordance with the one or more control messages.

Aspect 34: The method of any of aspects 28 through 33, wherein the one or more activation rules indicate for the UE to selectively activate one or more of the set of CSI-RS resources in accordance with a type of resource corresponding to each of the set of CSI-RS resources, an LTM execution condition corresponding to each of the set of CSI-RS resources, a frequency band corresponding to each of the set of CSI-RS resources, an LTM channel state information resource corresponding to each of the set of CSI-RS resources, or any combination thereof.

Aspect 35: The method of any of aspects 28 through 34, further comprising: receiving one or more control messages indicating the one or more activation rules.

Aspect 36: A network entity for wireless communications, comprising a processing system that includes processor circuitry and memory circuitry that stores code, the processing system configured to cause the network entity to perform a method of any of aspects 1 through 12.

Aspect 37: A network entity for wireless communications, comprising at least one means for performing a method of any of aspects 1 through 12.

Aspect 38: A non-transitory computer-readable medium storing code for wireless communications, the code comprising instructions executable by one or more processors to perform a method of any of aspects 1 through 12.

Aspect 39: A first network entity for wireless communications, comprising a processing system that includes processor circuitry and memory circuitry that stores code, the processing system configured to cause the first network entity to perform a method of any of aspects 13 through 20.

Aspect 40: A first network entity for wireless communications, comprising at least one means for performing a method of any of aspects 13 through 20.

Aspect 41: A non-transitory computer-readable medium storing code for wireless communications, the code comprising instructions executable by one or more processors to perform a method of any of aspects 13 through 20.

Aspect 42: A UE for wireless communications, comprising a processing system that includes processor circuitry and memory circuitry that stores code, the processing system configured to cause the UE to perform a method of any of aspects 21 through 27.

Aspect 43: A UE for wireless communications, comprising at least one means for performing a method of any of aspects 21 through 27.

Aspect 44: A non-transitory computer-readable medium storing code for wireless communications, the code comprising instructions executable by one or more processors to perform a method of any of aspects 21 through 27.

Aspect 45: A UE for wireless communications, comprising a processing system that includes processor circuitry and memory circuitry that stores code, the processing system configured to cause the UE to perform a method of any of aspects 28 through 35.

Aspect 46: A UE for wireless communications, comprising at least one means for performing a method of any of aspects 28 through 35.

Aspect 47: A non-transitory computer-readable medium storing code for wireless communications, the code comprising instructions executable by one or more processors to perform a method of any of aspects 28 through 35.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
a processing system that includes processor circuitry and memory circuitry that stores code, the processing system configured to cause the first network entity to:
output a lower-layer triggered mobility cell switch command; and
determine a post-cell switch activation status of each of one or more channel state information reference signal resources at a user equipment (UE) associated with the lower-layer triggered mobility cell switch command based at least in part on selecting respective sets of the one or more channel state information reference signal resources to activate or deactivate for the UE, wherein the post-cell switch activation status is based at least in part on a pre-cell switch activation status of the one or more channel state information reference signal resources at the UE.

2. The first network entity of claim 1, wherein the processing system is further configured to cause the first network entity to:
output, via the lower-layer triggered mobility cell switch notification message, an indication of the pre-cell switch activation status of the one or more channel state information reference signal resources.

3. The first network entity of claim 2, wherein the indication of the pre-cell switch activation status comprises an indication of one or more channel state information reference signal resource identifiers corresponding to one or more activated channel state information reference signal resources, one or more transmission configuration indicator state identifiers corresponding to the one or more activated channel state information reference signal resources, one or more channel state information reference signal resource identifiers corresponding to one or more deactivated channel state information reference signal resources, one or more transmission configuration indicator states corresponding to the one or more deactivated channel state information reference signal resources, or any combination thereof.

4. The first network entity of claim , wherein the processing system is further configured to cause the first network entity to:
obtain one or more measurement reports indicating a set of measurements of one or more channel state information reference signals, wherein selecting the respective sets of the one or more channel state information reference signal resources is based at least in part on the set of measurements and the pre-cell switch activation status.

5. The first network entity of claim 1, wherein the indication of the post-cell switch activation status comprises an indication of one or more channel state information reference signal resource identifiers corresponding to one or more activated channel state information reference signal resources, one or more transmission configuration indicator state identifiers corresponding to the one or more activated channel state information reference signal resources, one or more channel state information reference signal resource identifiers corresponding to one or more deactivated channel state information reference signal resources, one or more transmission configuration indicator states corresponding to the one or more deactivated channel state information reference signal resources, or any combination thereof.

6. The first network entity of claim 1, wherein the lower-layer triggered mobility cell switch notification message is output via an F1-AP interface.

7. The first network entity of claim 1, wherein the lower-layer triggered mobility cell switch notification message is output via an Xn-AP interface.

8. A user equipment (UE), comprising:
a processing system that includes processor circuitry and memory circuitry that stores code, the processing system configured to cause the UE to:
perform a lower-layer triggered mobility cell switch from a source cell to a target cell;
determine, in accordance with a post-cell switch activation status for a set of channel state information reference signal resources, which channel state information reference signal resources of the set of channel state information reference signal resources are to be activated or deactivated after the lower-layer triggered mobility cell switch; and
monitor for one or more channel state information reference signals via one or more of the set of channel state information reference signal resources in accordance with the post-cell switch activation status.

9. The UE of claim 8, wherein the processing system is further configured to cause the UE to:
receive one or more control messages comprising the indication of the post-cell switch activation status, wherein determining which channel state information reference signal resources are to be activated or deactivated is in accordance with the post-cell switch activation status.

10. The UE of claim 9, wherein the indication of the post-cell switch activation status comprises an indication of lower-layer triggered mobility channel state information resources, channel state information reference signal resource sets, channel state information reference signal resource identifiers, or any combination thereof.

11. The UE of claim 9, wherein the one or more control messages comprise one or more radio resource control messages indicating one or more channel state information reference signal resources to remain activated after the lower-layer triggered mobility cell switch, one or more channel state information reference signal resources to activate after the lower-layer triggered mobility cell switch, one or more channel state information reference signal resources to remain deactivated after the lower-layer triggered mobility cell switch, one or more channel state information reference signal resources to deactivate after the lower-layer triggered mobility cell switch, or any combination thereof.

12. The UE of claim 9, wherein the one or more control messages comprise one or more medium access control-control elements indicating one or more channel state information reference signal resources to remain activated after the lower-layer triggered mobility cell switch, one or more channel state information reference signal resources to activate after the lower-layer triggered mobility cell switch, one or more channel state information reference signal resources to remain deactivated after the lower-layer triggered mobility cell switch, one or more channel state information reference signal resources to deactivate after the lower-layer triggered mobility cell switch, or any combination thereof.

13. The UE of claim 12, wherein:
the one or more medium access control-control elements comprise a lower-layer triggered mobility cell switch command, and
performing the lower-layer triggered mobility cell switch is in accordance with the lower-layer triggered mobility cell switch command.

14. The UE of claim 8, wherein the processing system is further configured to cause the UE to:
perform a second lower-layer triggered mobility cell switch from a second source cell to a second target cell; and
determine which channel state information reference signal resources of the set of channel state information reference signal resources are to be activated or deactivated after the second lower-layer triggered mobility cell switch, wherein determining which channel state information reference signal resources of the set of channel state information reference signal resources are to be activated or deactivated is in accordance with an absence of the indication of the post-cell switch activation status.

15. A user equipment (UE), comprising:
a processing system that includes processor circuitry and memory circuitry that stores code, the processing system configured to cause the UE to:
perform a lower-layer triggered mobility cell switch from a source cell to a target cell;
determine, in accordance with one or more activation rules that indicate a post-cell switch activation status for a set of channel state information reference signal resources, which channel state information reference signal resources of the set of channel state information reference signal resources are to be activated or deactivated after the lower-layer triggered mobility cell switch; and
monitor for one or more channel state information reference signals via one or more of the set of channel state information reference signal resources in accordance with the post-cell switch activation status.

16. The UE of claim 15, wherein the one or more activation rules indicate that the UE is to maintain a pre-cell switch activation status corresponding to the set of channel state information reference signal resources.

17. The UE of claim 15, wherein the one or more activation rules indicate that the UE is to activate one or more lower-layer triggered mobility channel state information resources corresponding to at least one previously activated set of channel state information reference signal resources.

18. The UE of claim 15, wherein the one or more activation rules indicate that the UE is to activate one or more lower-layer triggered mobility channel state information resources corresponding to each previously activated set of channel state information reference signal resources.

19. The UE of claim 15, wherein the one or more activation rules indicate for the UE to deactivate the set of channel state information reference signal resources.

20. The UE of claim 19, wherein the processing system is further configured to cause the UE to:
receive one or more control messages indicating for the UE to activate one or more of the set of channel state information reference signal resources, wherein monitoring for the one or more channel state information reference signals is in accordance with the one or more control messages.
